(19) United States
(12) Patent Application Publication
(10) Pub. No.: US 2017/0342578 A1
(43) Pub. Date: Nov. 30, 2017

(54) A NEW CLASS OF ELECTROCATALYSTS

(71) Applicant: WILLIAM MARCH RICE UNIVERSITY, Houston, TX (US)

(72) Inventors: James M. Tour, Bellaire, TX (US); Huilong Fei, Houston, TX (US)

(73) Assignee: William Marsh Rice University, Houston, TX (US)

(21) Appl. No.: 15/526,007

(22) PCT Filed: Nov. 11, 2015
(86) PCT No.: PCT/US15/60094

§ 371 Date: May 11, 2017

Related U.S. Application Data
(60) Provisional application No. 62/078,282, filed on Nov. 11, 2014.

(51) Int. Cl. C25B 11/04; H01M 4/90; H01M 4/88; H01M 4/92

(52) U.S. Cl. CPC C25B 11/0478; H01M 4/925; H01M 4/92; H01M 4/9083; H01M 4/8825; H01M 4/9016; H01M 4/8878; H01M 4/9075

(57) ABSTRACT

Embodiments of the present disclosure pertain to electrocatalysts that include a surface and a plurality of catalytically active sites associated with the surface. The catalytically active sites include individually dispersed metallic atoms that are associated with heteroatoms. In some embodiments, the surface includes graphene oxide, the heteroatoms include nitrogen, and the metallic atoms include cobalt. Additional embodiments of the present disclosure pertain to methods of mediating an electrocatalytic reaction by exposing a precursor material to an electrocatalyst of the present disclosure. In some embodiments, the electrocatalytic reaction is a hydrogen evolution reaction that results in the formation of molecular hydrogen from the precursor material. Further embodiments of the present disclosure pertain to methods of making the electrocatalysts of the present disclosure by associating a surface with heteroatoms and metallic atoms.

### CROSS-REFERENCE TO RELATED APPLICATIONS

This application claims priority to U.S. Provisional Patent Application No. 62/078,282, filed on Nov. 11, 2014. The entirety of the aforementioned application is incorporated herein by reference.

### STATEMENT REGARDING FEDERALLY SPONSORED RESEARCH

This invention was made with government support under Grant No. FA9550-14-1-0111, awarded by the U.S. Department of Defense; Grant No. FA9550-12-1-0035, awarded by the U.S. Department of Defense; and Grant No. N00014-09-1-1066, awarded by the U.S. Department of Defense. The government has certain rights in the invention.

### BACKGROUND

Many electrocatalytic reactions (e.g., reduction of water to hydrogen) hold great promise in numerous fields, including clean energy. However, a broader application of electrocatalytic reactions would require the large-scale development of inexpensive and efficient electrocatalysts that could replace conventional catalysts, such as precious platinum catalysts.

### SUMMARY

In some embodiments, the present disclosure pertains to electrocatalysts for mediating various electrocatalytic reactions. In some embodiments, the electrocatalysts include a surface and a plurality of catalytically active sites associated with the surface. In some embodiments, the catalytically active sites include individually dispersed metallic atoms that are associated with heteroatoms.

In some embodiments, the surface includes graphene oxide, such as porous graphene oxide. In some embodiments, the heteroatoms include, without limitation, boron, nitrogen, oxygen, phosphorous, silicon, sulfur, chlorine, bromine, iodine, and combinations thereof. In some embodiments, the heteroatoms include nitrogen.

In some embodiments, the metallic atoms include, without limitation, metals, metal oxides, transition metals, metal carbides, transition metal oxides, cobalt, iron, nickel, molybdenum, platinum, palladium, gold, manganese, copper, zinc, and combinations thereof. In some embodiments, the metallic atoms include cobalt.

In some embodiments, the metallic atoms have a concentration of less than about 5.0 at % of the electrocatalyst. In some embodiments, the metallic atoms have a concentration ranging from about 0.01 at % to about 2.0 at % of the electrocatalyst.

In some embodiments, the electrocatalyst is capable of mediating oxygen reduction reactions, oxygen evolution reactions, hydrogen oxidation reactions, hydrogen evolution reactions, and combinations thereof. In some embodiments, the electrocatalyst is capable of mediating hydrogen evolution reactions.

Additional embodiments pertain to methods of mediating an electrocatalytic reaction by exposing a precursor material to an electrocatalyst of the present disclosure. In some embodiments, the electrocatalytic reaction is a hydrogen evolution reaction that results in the formation of molecular hydrogen from the precursor material. In some embodiments, the precursor material is water.

Further embodiments of the present disclosure pertain to methods of making the electrocatalysts of the present disclosure. In some embodiments, such embodiments involve associating a surface with heteroatoms and metallic atoms. In some embodiments, the associating results in the formation of a plurality of catalytically active sites that include individually dispersed metallic atoms that are associated with heteroatoms.

### DESCRIPTION OF THE FIGURES

FIG. 1 provides a scheme of a method of making electrocatalysts.

FIG. 2 provides data relating to the preparation and morphology characterizations of cobalt-based electrocatalysts, where the cobalt has been applied onto nitrogen-doped graphene (denoted as Co-NG catalyst). FIG. 2A provides a schematic illustration of the synthetic procedure for the fabrication of the Co-NG catalyst. FIG. 2B provides a scanning electron microscopy (SEM) image of the Co-NG nanosheets. The scale bar is 2 μm. FIG. 2C provides a transmission electron microscopy (TEM) image of the Co-NG nanosheets atop a lacey carbon TEM grid. The scale bar is 50 nm. FIG. 2D provides an SEM image showing the cross-section view of the Co-NG paper with a thickness of 15 μm, prepared by filtration of Co-containing GO suspension followed by NH₃-annealing. The scale bar is 20 μm. The inset shows the optical image of a 2×1 cm² Co-NG paper.

FIG. 3 provides data relating to the compositional characterizations of Co-NGs. FIG. 3A provides an x-ray photoelectron spectroscopy (XPS) survey spectra of Co-NG, NG and Co-G. FIG. 3B provides a chart showing the percentages of cobalt, nitrogen, oxygen and carbon in the Co-NG measured by XPS and ICP-OES. FIGS. 3C-D show high-resolution XPS Co 2p and N 1s spectra, respectively. FIG. 3E shows a scanning TEM (STEM) image of the Co-NG nanosheet. The scale bar is 20 nm. The inset is the energy-dispersive X-ray spectroscopy (EDS) elemental line scan from A to B, showing the presence of C, N and Co elements.

FIG. 4 provides XPS C 1s (FIG. 4A) and XPS O is (FIG. 4B) spectra of the Co-NG.

FIG. 5 provides an STEM-EDS measurement of the Co-NG taken in the region shown in FIG. 3E. The spectrum shows the presence of the Co, N, C and O from the sample. The Au signal is from the TEM grid. The Si signal occurs from the spurious Si emission from the EDS detector.

FIG. 6 provides data relating to the structural characterizations on the Co-NG. FIG. 6A provides a bright-field aberration-corrected STEM image of the Co-NG, showing the defective and disordered graphitic carbon structures. The scale bar is 1 nm. FIG. 6B shows a high-angle annular dark field HAADF-STEM image of the Co-NG, showing many Co atoms well-dispersed in the carbon matrix. The scale bar is 1 nm. FIG. 6C shows an enlarged view of the selected area in FIG. 6B. The scale bar is 0.5 nm. FIGS. 6D-E show the k²-weighted extended X-ray absorption fine structure (EXAFS) analyses in k-space and their Fourier transforms in R space for the Co-NG and Co-G, respectively. FIG. 6F shows a wavelet transforms for the Co-NG and Co-G. The location of the maximum A shifts from 3.2 Å⁻¹ for Co-G to 3.4 Å⁻¹ for Co-NG, indicating the presence of Co—N bonding in Co-NG. The vertical dashed lines are provided to guide the eye.

FIG. 7 provides additional aberration-corrected STEM images (dark-field), showing the atomic distributions of the Co atoms. The lower magnification STEM in FIG. 7A indicates that the majority of the cobalt are isolated as individual atoms, except for some small portions of aggregated clusters. Higher magnification STEM images are shown in FIGS. 7B-C.

FIG. 8 provides a comparison of the q-space magnitudes for free energy force field (FEFF)-calculated, k²-weighted EXAFS paths. FIG. 8A shows the effect of the path length R on the Co—C path (with σ² and ΔE fixed at 0.003 Å² and 0 eV, respectively). FIG. 8B shows the effect of the Debye-Waller factors σ² on the Co—C path (with R and ΔE fixed at 2 Å and 0 eV, respectively). FIG. 8C shows the effect of the energy shift ΔE on the Co—C path (with R and σ² fixed at 2 Å and 0.003 Å², respectively). FIG. 8D shows the effect of atomic number Z (with R, σ⁻² and ΔE fixed at 2 Å, 0.003 Å², and 0 eV, respectively).

FIG. 9 shows the reduced χ² (red column) and R-factor (blue column) for the five structural models (the pure Co—C path, a mixture of Co—C and Co—N paths, pure Co—N path, a mixture of Co—N and Co—O paths, and pure Co—O path) used to describe the local structure of the Co-NG.

FIG. 10 provides a comparison between the experimental EXAFS spectrum of Co-NG and the best-fit result using the mixed model in k (FIG. 10A) and R spaces (FIG. 10B).

FIG. 11 shows hydrogen evolution reaction (HER) activity characterizations. FIG. 11A shows linear-sweep voltammograms (LSV) of NG, Co-G, Co-NG and Pt/C in 0.5 M H₂SO₄ at scan rates of 2 mV s⁻¹. The inset shows the enlarged view of the LSV for the Co-NG near the onset region. FIG. 11B is a plot showing the molar number of H₂ produced as a function of time. The straight line represents the theoretically calculated amounts of H₂ (assuming 100% Faradaic efficiency), and the scattered dots represent the produced H₂ measured by gas chromatography. The overlapping of these two sets of data indicates that nearly all the current is due to H₂ evolution. The error bars arise from instrument uncertainty. FIG. 11C shows Tafel plots of the polarization curves in FIG. 11A. FIG. 11D shows turnover frequency (TOF) values of the Co-NG catalyst (black line) along with TOF values for other recently reported catalysts.

FIG. 12 shows gas chromatography (GC) signals for the Co-NG electrode and Pt reference electrode after a 5 minute reaction.

FIG. 13 provides polarization curves of NG, Co-G, Co-NG and Pt/C in 1 M NaOH electrolyte at a scan rate of 2 mV s⁻¹.

FIG. 14 provides SEM images of the Co-NG flakes on carbon fiber paper (CFP).

FIG. 15 provides various data relating to the performance of Co-NGs on CFP electrodes. FIG. 15A provides cyclic voltammetry (CV) curves (0.5 M H₂SO₄, scan rate of 50 mV s⁻¹, not iR-corrected) of Co-NG on CFP electrodes and NG on CFP electrodes. Mass loading is ˜40 μg cm⁻². The inset shows the enlarged view near the onset region. FIG. 15B shows the current density versus time response at a constant η of 300 mV. The inset is the photograph of the Co-NG on the CFP electrode and shows that the surface is covered with H₂ bubbles after 30 seconds.

FIG. 16 provides data relating to the performance of various catalysts shown in Table 2. FIG. 16A provides LSV polarization curves for the catalysts with different Co contents shown in Table 2. FIG. 16B shows the η@ 10 mA cm⁻² for the catalysts with different Co contents shown in Table 2. The error bars arise from standard deviations obtained from multiple electrodes on multiple samples.

FIG. 17 provides Tafel plots obtained from the polarization curves for catalysts with different Co contents shown in Table 2.

FIG. 18 shows O1s XPS peak for the Co-NG4 and Co-NG5 listed in Table 2.

FIG. 19 provides XPS survey spectra for samples with different N doping concentrations prepared by varying the doping time from 15 minutes to 60 minutes.

FIG. 20 provides XPS N 1s spectra for samples with different N doping concentrations prepared by varying the doping time from 15 minutes to 60 minutes.

FIG. 21 provides LSV polarization curves for samples with different N doping concentrations prepared by varying the doping time from 15 minutes to 60 minutes.

FIG. 22 provides data relating to the performance of various catalysts. FIG. 22A shows LSV polarization curves for catalysts annealed at different temperatures. FIG. 22B shows the η@ 10 mA cm⁻² for the catalysts annealed at different temperatures.

FIG. 23 shows deconvoluted N1s XPS of Co-NG annealed at 350° C. (FIG. 23A), 450° C. (FIG. 23B), 550° C. (FIG. 23C), 650° C. (FIG. 23D), and 850° C. (FIG. 23E). The N1s was deconvoluted into four types: pyridinic/N—Co (398.4 eV), pyrrolic (399.8 eV), graphitic (401.2 eV), and N-oxide (402.8). FIG. 23F shows the relationship between the percentages of the different N species and the annealing temperatures.

FIG. 24 shows double-layer capacitance measurements for determining the electrochemical active surface area for the Co-NG with mass loading of 285 μg cm⁻². FIG. 24A shows CVs measured in a non-Faradaic region at a scan rate of 10 mV s⁻¹, 20 mV s⁻¹, 40 mV s⁻¹, 60 mV s⁻¹, 80 mV s⁻¹, and 100 mV s⁻¹. FIG. 24B shows the cathodic (red) and anodic (blue) currents measured at 0.1 V vs RHE as a function of the scan rate. The average of the absolute value of the slope is taken as the double-layer capacitance of the electrode.

FIG. 25 shows various HER stability tests. FIG. 25A shows accelerated stability measurements by recording the polarization curves for the Co-NG catalyst before and after 1000 cyclic voltammograms at a scan rate of 50 mV s⁻¹ under acidic (black curves) and basic conditions (red curves). FIG. 25B shows a plot of η versus t for the Co-NG catalyst at a constant cathodic current density of 10 mA cm⁻² under acidic and basic conditions.

FIG. 26 shows XPS survey spectra of the Co-NG after cycling.

FIG. 27 shows the XPS Co 2p spectra (FIG. 27A) and the XPS N is spectra (FIG. 27B) of Co-NG after cycling.

FIG. 28 shows the XRD patterns of Co-NG before and after cycling.

FIG. 29 shows an HAADF-STEM image of the Co-NG after cycling.

FIG. 30 shows the calibration of a Hg/HgSO₄, K₂SO₄ (sat) reference electrode in 0.5 M H₂SO₄.

FIG. 31 shows the calibration of a Hg/HgO, NaOH (1 M) reference electrode in 1 M NaOH.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Electrochemical reduction of water through the hydrogen evolution reaction (HER) is a clean and sustainable approach to generate molecular hydrogen (H₂), which has been proposed as a future energy carrier. Catalysts are needed to improve HER efficiency by minimizing reaction kinetic barriers, which manifest themselves as overpotentials (η). Though platinum (Pt) is the most active HER catalyst, its scarcity and high costs limit its widespread use.

A transition to a hydrogen economy calls for alternative electrocatalysts based on earth-abundant elements, such as non-precious metal oxides, sulfides, phosphides, carbides and borides. In spite of their low η for HER, the active sites of these inorganic-solid catalysts, like other heterogeneous catalysts, are sparsely distributed at selective sites (i.e., surface sites or edges sites).

In order to expose more active sites, these catalysts are generally downsized into nanoparticulate form and stabilized onto certain substrates. Graphene is such a substrate that has a large specific surface area (high catalyst loading), good stability (tolerance to harsh operational conditions) as well as a high electrical conductivity (facilitated electron transfer). Therefore, graphene has been widely used to disperse nanoparticles for advanced electrocatalysis. The dispersing ability of graphene is, however, far from being fulfilled unless single atom catalysis (SAC) is achieved.

SAC represents the lowest size limit to obtain full atom utility in a catalyst and has recently emerged as a new research frontier. Although an increasing number of SAC systems have been reported, most have focused on supporting noble metal atoms (e.g., Pt, Au, Pd) on metal oxide or metal surfaces with a limited number of applications demonstrated. Moreover, wide employment of SAC is hampered due to the lack of readily available synthetic approaches originated from the aggregation tendency of single atoms.

As such, a need exists for more effective electrocatalysts that utilize SAC to mediate electrocatalytic reactions. The present disclosure addresses this need.

In some embodiments, the present disclosure pertains to novel electrocatalysts that include a surface and a plurality of catalytically active sites associated with the surface. In some embodiments, the catalytically active sites include individually dispersed metallic atoms that are associated with heteroatoms.

In some embodiments, the present disclosure pertains to methods of mediating electrocatalytic reactions by exposing a precursor material to an electrocatalyst of the present disclosure. Further embodiments of the present disclosure pertain to methods of making the electrocatalysts of the present disclosure.

As set forth in more detail herein, the electrocatalysts of the present disclosure can include various types of surfaces, metallic atoms, and heteroatoms in various arrangements. Moreover, the electrocatalysts of the present disclosure may be utilized to mediate various types of electrocatalytic reactions. Furthermore, various methods may be utilized to make the electrocatalysts of the present disclosure.

Surfaces

The electrocatalysts of the present disclosure may include various types of surfaces. In some embodiments, suitable surfaces can include any surfaces that can support a plurality of catalytically active sites. In some embodiments, the surfaces include, without limitation, carbon materials, graphite, graphitic surfaces, graphite oxide, graphene, graphene oxide, graphene nanoribbons, graphene oxide nanoribbons, carbon nanofibers, carbon nanotubes, split carbon nanotubes, activated carbon, carbon black, metal chalcogenides, molybdenum disulfide (MoS₂), molybdenum trisulfide (MoS₃), titanium diselenide (TiSe₂), molybdenum diselenide (MoSe₂), tungsten diselenide (WSe₂), tungsten disulfide (WS₂), niobium triselenide (NbSe₃), functionalized surfaces, pristine surfaces, doped surfaces, reduced surfaces, porous surfaces, porous carbons, high surface area porous carbons, high surface area porous carbons made from asphalt, stacks thereof, and combinations thereof.

In some embodiments, electrocatalyst surfaces include carbon-based surfaces. Suitable carbon-based surfaces can include, without limitation, carbon materials, graphite, graphitic surfaces, graphite oxide, graphene, graphene oxide, graphene nanoribbons, graphene oxide nanoribbons, carbon nanofibers, carbon nanotubes, split carbon nanotubes, activated carbon, carbon black, fullerene, high surface area porous carbons, and combinations thereof.

In some embodiments, the electrocatalyst surfaces of the present disclosure include high surface area porous carbons. In some embodiments, the high surface area porous carbons are made from asphalt and potassium hydroxide.

In some embodiments, electrocatalyst surfaces include graphene-based surfaces. Suitable graphene-based surfaces can include, without limitation, graphite, graphitic surfaces, graphite oxide, graphene, graphene oxide, graphene nanoribbons, graphene oxide nanoribbons, and combinations thereof. In some embodiments, the surface includes graphene oxide.

In some embodiments, electrocatalyst surfaces include porous surfaces. In some embodiments, the porous surfaces include pores with diameters that range from about 1 nm to about 5 μm. In some embodiments, the porous surfaces include pores with diameters that range from about 1 nm to about 500 nm. In some embodiments, the porous surfaces include pores with diameters that range from about 5 nm to about 100 nm. Additional pore sizes can also be envisioned.

In some embodiments, electrocatalyst surfaces may be functionalized with a plurality of functional groups. In some embodiments, the functional groups include, without limitation, amorphous carbon, oxygen groups, carbonyl groups, carboxyl groups, hydroxyl groups, esters, amines, amides, alkyls, aromatics, and combinations thereof.

The electrocatalyst surfaces of the present disclosure can also have various structures. For instance, in some embodiments, the electrocatalyst surfaces include a disordered structure. In some embodiments, the electrocatalyst surfaces include a plurality of conjugated domains. In some embodiments, the electrocatalyst surfaces include a plurality of aromatic domains. In some embodiments, the electrocatalyst surfaces are in the form of a sheet.

The electrocatalyst surfaces of the present disclosure can also have various layers. For instance, in some embodiments, the electrocatalyst surfaces include a single layer. In some embodiments, the electrocatalyst surfaces include multiple layers. In some embodiments, the electrocatalyst surfaces include from about 2 layers to about 100 layers. In some embodiments, the electrocatalyst surfaces include from about 2 layers to about 10 layers.

The electrocatalyst surfaces of the present disclosure can also have various sizes. For instance, in some embodiments, the electrocatalyst surfaces include surface sizes that range from about 0.1 mm² to about 100 m². In some embodiments, the electrocatalyst surfaces include surface sizes that range from about 1 mm² to about 1 m². In some embodiments, the electrocatalyst surfaces include surface sizes that range from about 1 mm² to about 100 cm². In some embodiments, the electrocatalyst surfaces include surface sizes that range from about 10 mm² to about 10 cm².

Catalytically Active Sites

The electrocatalysts of the present disclosure can include various types of catalytically active sites. Catalytically active sites generally refer to sites associated with an electrocatalyst surface that are capable of mediating electrocatalytic reactions. In some embodiments, the catalytically active sites are connected to one another. In some embodiments, the catalytically active form distinct sites on an electrocatalyst surface. In some embodiments, the catalytically active sites include individually dispersed metallic atoms that are associated with heteroatoms.

The electrocatalysts of the present disclosure can include various amounts of catalytically active sites on a surface. For instance, in some embodiments, the electrocatalysts of the present disclosure can include from about 1.0×10¹² catalytically active sites per cm² to about 1×10¹⁵ catalytically active sites per cm². In some embodiments, the electrocatalysts of the present disclosure can include from about 1.0×10¹³ catalytically active sites per cm² to about 1×10¹⁴ catalytically active sites per cm². In some embodiments, the electrocatalysts of the present disclosure can include from about 5.0×10¹³ catalytically active sites per cm² to about 1×10¹⁴ catalytically active sites per cm². In some embodiments, the electrocatalysts of the present disclosure can include from about 9.0×10¹³ catalytically active sites per cm² to about 1×10¹⁴ catalytically active sites per cm². In some embodiments, the electrocatalysts of the present disclosure can include about 9.7×10¹³ catalytically active sites per cm².

As set forth in more detail herein, the catalytically active sites of the present disclosure can include various types of heteroatoms and metallic atoms. Moreover, metallic atoms may be associated with heteroatoms in various manners.

Heteroatoms

The catalytically active sites of the present disclosure can include various types of heteroatoms. In some embodiments, the heteroatoms include, without limitation, boron, nitrogen, oxygen, phosphorous, silicon, sulfur, chlorine, bromine, iodine, and combinations thereof. In some embodiments, the heteroatoms include boron and nitrogen. In some embodiments, the heteroatoms include nitrogen. In some embodiments, the heteroatoms include boron nitride.

The electrocatalysts of the present disclosure can include various amounts of heteroatoms. For instance, in some embodiments, the heteroatoms have a concentration ranging from about 0.5 at % to about 10 at % of the electrocatalyst. In some embodiments, the heteroatoms have a concentration ranging from about 3 at % to about 9 at % of the electrocatalyst. In some embodiments, the heteroatoms have a concentration of about 8 at % of the electrocatalyst.

Metallic Atoms

The catalytically active sites of the present disclosure can also include various types of metallic atoms. For instance, in some embodiments, the metallic atoms include, without limitation, metals, metal oxides, transition metals, metal carbides, transition metal oxides, cobalt, iron, nickel, molybdenum, platinum, palladium, gold, manganese, copper, zinc, and combinations thereof. In some embodiments, the metallic atoms include cobalt. In some embodiments, the metallic atoms exclude noble metals, such as platinum, gold, palladium, and combinations thereof.

The electrocatalysts of the present disclosure can include various amounts of metallic atoms. For instance, in some embodiments, the metallic atoms have a concentration ranging from about 0.01 at % to about 10 at % of the electrocatalyst. In some embodiments, the metallic atoms have a concentration ranging from about 0.01 at % to about 5 at % of the electrocatalyst. In some embodiments, the metallic atoms have a concentration of about 0.01 at % to about 2.0 at % of the electrocatalyst. In some embodiments, the metallic atoms have a concentration of about 0.01 at % to about 3.0 at % of the electrocatalyst. In some embodiments, the metallic atoms have a concentration ranging from about 0.01 at % to about 0.6 at % of the electrocatalyst.

In some embodiments, the metallic atoms have a concentration of less than about 5 at % of the electrocatalyst. In some embodiments, the metallic atoms have a concentration of less than about 3 at % of the electrocatalyst. In some embodiments, the metallic atoms have a concentration of less than about 1.5 at % of the electrocatalyst.

Arrangements

Metallic atoms may be associated with heteroatoms through various types of interactions. For instance, in some embodiments, such interactions can include, without limitation, at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof. In some embodiments, metallic atoms are coordinated with heteroatoms.

In some embodiments, heteroatoms form an interconnected network on a surface of an electrocatalyst. In some embodiments, the heteroatom network is in the form of a lattice or a matrix on the surface of the electrocatalyst. In some embodiments, the heteroatom network provides incorporation sites for the metallic atoms. In some embodiments, metallic atoms become individually dispersed within the heteroatom network. In some embodiments, metallic atoms are isolated as individual atoms within the heteroatom network.

The electrocatalysts of the present disclosure can have various shapes. For instance, in some embodiments, the electrocatalysts of the present disclosure are free-standing. In some embodiments, the electrocatalysts of the present disclosure are in the form of a paper. In some embodiments, the electrocatalysts of the present disclosure are in the form of particles. In some embodiments, the electrocatalysts of the present disclosure are in the form of nanosheets.

The electrocatalysts of the present disclosure may also be associated with various materials. For instance, in some embodiments, the electrocatalysts of the present disclosure are associated with carbon fiber paper. In some embodiments, the electrocatalysts of the present disclosure are utilized as a component of an electronic device. In some embodiments, the electronic device includes, without limitation, energy storage devices, batteries, electrodes, and combinations thereof.

Electrocatalysis

In additional embodiments, the present disclosure pertains to methods of mediating electrocatalytic reactions. In some embodiments, such methods involve exposing a precursor material to an electrocatalyst of the present disclosure. Suitable electrocatalysts were described previously. As set forth in more detail herein, various methods may be utilized to expose various types of precursor materials to an electrocatalyst to mediate various types of electrocatalytic reactions.

Electrocatalytic Reactions

The electrocatalysts of the present disclosure can be utilized to mediate various types of electrocatalytic reactions. For instance, in some embodiments, the electrocatalysts of the present disclosure are utilized to mediate oxygen reduction reactions, oxygen evolution reactions, hydrogen oxidation reactions, hydrogen evolution reactions, and combinations thereof. In more specific embodiments, the electrocatalysts of the present disclosure are utilized to mediate CO₂ reduction reactions, methanol oxidation reactions, hydrogen oxidation reactions, and combinations thereof.

In some embodiments, the electrocatalysts of the present disclosure are utilized to mediate hydrogen evolution reactions. For instance, in some embodiments, the electrocatalysts of the present disclosure mediate the formation of molecular hydrogen (H₂) from a suitable precursor material, such as water.

In some embodiments, the electrocatalysts of the present disclosure are utilized for mediating oxygen evolution reactions. In some embodiments, the electrocatalysts of the present disclosure are utilized for mediating hydrogen evolution reactions and oxygen evolution reactions.

Precursor Materials

The electrocatalysts of the present disclosure may be exposed to various precursor materials. For instance, in some embodiments, the precursor material includes water. In some embodiments, the precursor material includes an electrolyte, such as an acidic electrolyte, a basic electrolyte, and combinations thereof.

Exposing

Various methods may be utilized to expose a precursor material to an electrocatalyst. For instance, in some embodiments, the exposing occurs by a method that includes, without limitation, mixing, stirring, incubating, sonicating, heating, ion implantation, mechanical mixing, and combinations thereof. In some embodiments, the exposing occurs by incubating the electrocatalyst with the precursor material.

Methods of Making Electrocatalysts

In additional embodiments, the present disclosure pertains to methods of making the electrocatalysts of the present disclosure. In some embodiments, such methods include a step of associating a surface with heteroatoms and metallic atoms. In some embodiments, the association results in the formation of a plurality of catalytically active sites on the surface. In some embodiments, the catalytically active sites include individually dispersed metallic atoms that are associated with heteroatoms.

Suitable surfaces, heteroatoms and metallic atoms were described previously. As set forth in more detail herein, various association methods may be utilized to form the electrocatalysts of the present disclosure.

Association

Various methods may be utilized to associate metallic atoms and heteroatoms with a surface. For instance, in some embodiments, the association step includes, without limitation, mixing, stirring, sonication, freeze-drying, hydrothermal treatment, annealing, chemical vapor deposition, evaporation, mechanical mixing, ion implantation, and combinations thereof.

Association steps can occur in various sequences. For instance, in some embodiments, heteroatoms are associated with the surface after the metallic atoms are associated with the surface. Alternative association sequences can also be envisioned. For instance, in some embodiments, heteroatoms are associated with a surface before metallic atoms are associated with the surface. In some embodiments, heteroatoms and metallic atoms are simultaneously associated with the surface.

Metallic atoms and heteroatoms may be associated with surfaces by different methods. For instance, in some embodiments, metallic atoms are associated with the surface through freeze-drying while heteroatoms are associated with the surface through annealing. In some embodiments, the different association methods can include, without limitation, evaporation, mechanical mixing, ion implantation, and combinations thereof.

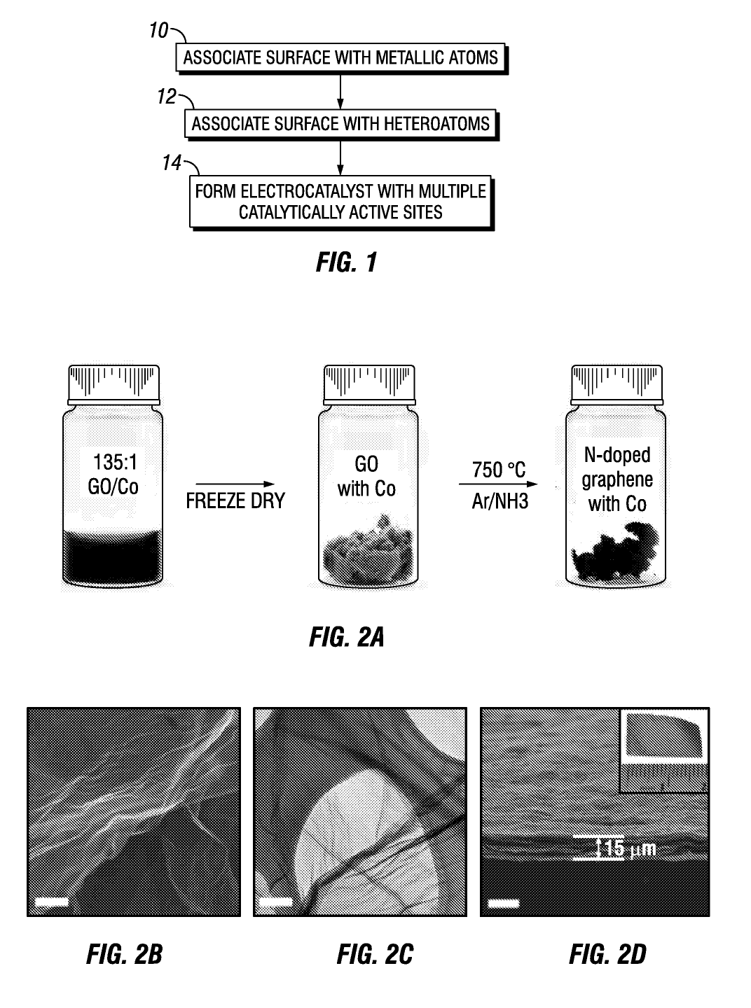

In more specific embodiments illustrated in FIG. 1, a surface is first associated with metallic atoms (step 10) by various methods, such as freeze-drying. Thereafter, the surface is associated with heteroatoms (step 12) by various methods, such as annealing. This in turn results in the formation of an electrocatalyst with a plurality of catalytically active sites on the surface (step 14).

Heteroatoms and metallic atoms may be associated with surfaces under various conditions. For instance, in some embodiments, the association occurs in an inert atmosphere, such as an atmosphere that is under the flow of an inert gas (e.g., nitrogen, argon, and combinations thereof). In some embodiments, the association occurs at ambient pressure. In some embodiments, the association occurs in an atmosphere that is under the flow of a hydrogen gas. In some embodiments, the association occurs in an atmosphere that is under the flow of a hydrogen gas and an inert gas (e.g., nitrogen, argon, and combinations thereof).

In some embodiments, the association occurs at high temperatures. For instance, in some embodiments, the association occurs at temperatures that range from about 350° C. to about 850° C. In some embodiments, the association occurs at temperatures of about 750° C.

Applications and Advantages

In some embodiments, the electrocatalysts of the present disclosure can function as highly active and robust electrocatalysts (e.g., hydrogen evolution reaction catalysts) in various environments. In some embodiments, the environments include both acidic and basic media.

Moreover, the electrocatalysts of the present disclosure can provide optimal catalytic performance, maximal efficiency of atomic utility, scalability and low preparation costs. For instance, in some embodiments, the electrocatalysts of the present disclosure can have overpotentials of less than about 100 millivolts. In some embodiments, the electrocatalysts of the present disclosure can have overpotentials of less than about 50 millivolts. In some embodiments, the electrocatalysts of the present disclosure can have overpotentials of less than about 40 millivolts. In some embodiments, the electrocatalysts of the present disclosure can have overpotentials of about 30 millivolts.

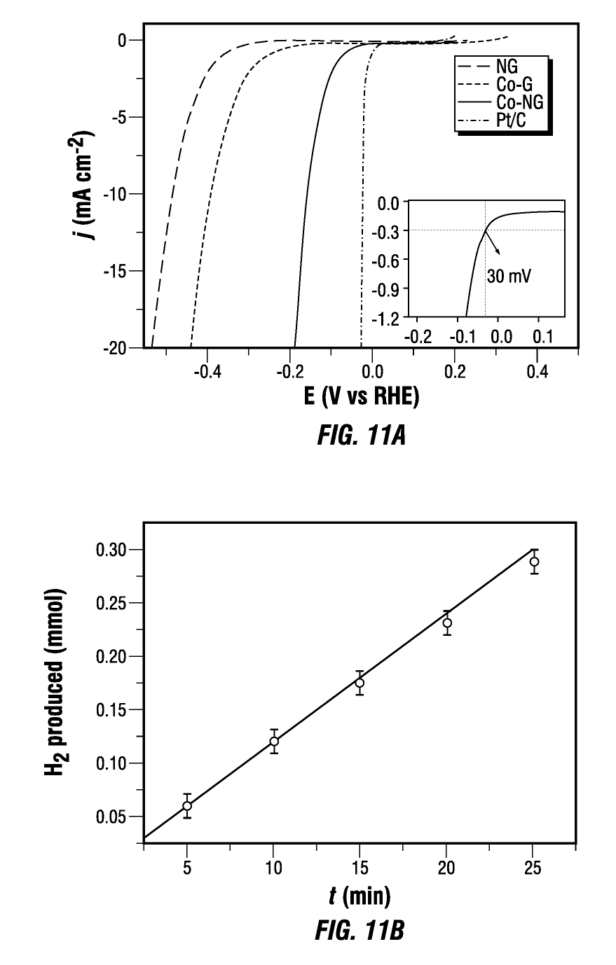

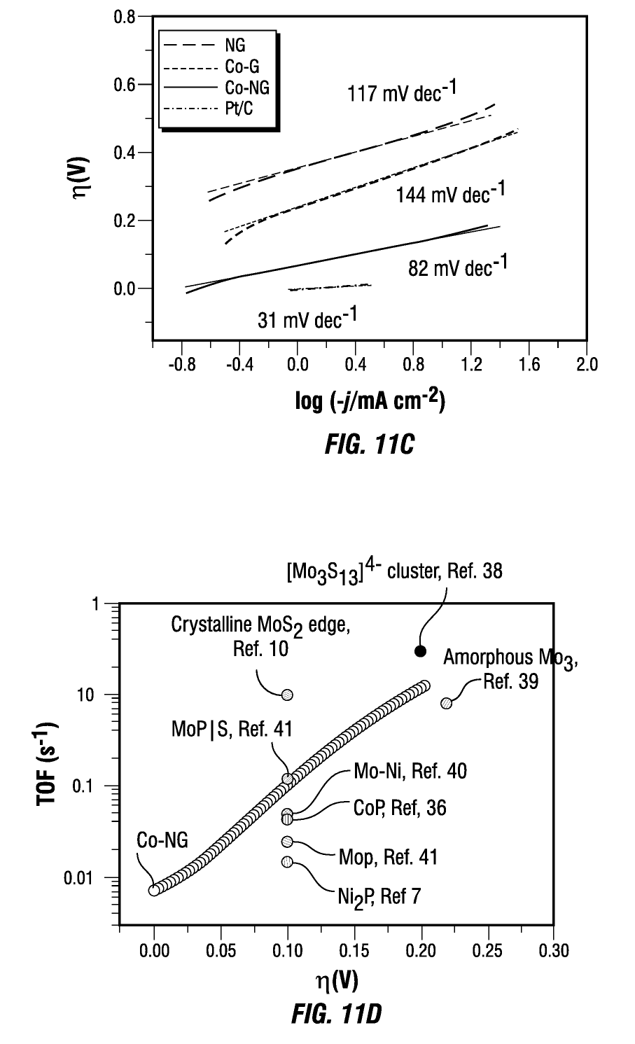

In some embodiments, the electrocatalysts of the present disclosure can obtain large currents at low voltages. For instance, in some embodiments, the electrocatalysts of the present disclosure can obtain currents of about −20 mA/cm² at voltages of about −0.18 V (see, e.g., FIG. 11A). In some embodiments, the electrocatalysts of the present disclosure can obtain currents of about 10 mA/cm² at voltages of about 147 mV.

As such, the electrocatalysts of the present disclosure can have numerous applications. For instance, in some embodiments, the electrocatalysts of the present disclosure represent the first example of single-atom catalysis achieved in inorganic solid-state catalysts for hydrogen evolution reactions. In some embodiments, the electrocatalysts of the present disclosure can be utilized as preferred replacements of platinum-based catalysts.

### ADDITIONAL EMBODIMENTS

Reference will now be made to more specific embodiments of the present disclosure and experimental results that provide support for such embodiments. However, Applicants note that the disclosure herein is for illustrative purposes only and is not intended to limit the scope of the claimed subject matter in any way.

### Example 1. Atomic Cobalt on Nitrogen-Doped Graphene for Hydrogen Generation

In this Example, Applicants report a new type of electrocatalyst for hydrogen generation based on very small amounts of cobalt dispersed as individual atoms on nitrogen-doped graphene. This catalyst is robust and exceptionally active in aqueous media with very low overpotentials (30 millivolts). A variety of analytical techniques and electrochemical measurements suggest that the catalytically active sites are associated with the metal centers coordinated to nitrogen. This unusual atomic constitution of supported metals is suggestive of a new approach to preparing extremely efficient single-atom catalysts.

This Example also provides an inexpensive, concise and scalable method to disperse the earth-abundant metal, cobalt, onto nitrogen-doped graphene (denoted as Co-NG) by simply heat-treating graphene oxide (GO) and small amounts of cobalt salts in a gaseous NH₃ atmosphere. These small amounts of cobalt atoms, coordinated to nitrogen atoms on the graphene, can work as extraordinary catalysts towards hydrogen evolution reactions (HER) in both acidic and basic water.

### Example 1.1. Synthesis and Characterization of the Co-NG Catalyst

To prepare the Co-NG catalyst, a precursor solution was first prepared by sonicating GO and cobalt salts (CoCl₂.6H₂O) (weight ratio GO:Co=135:1) in water. The well-mixed precursor solution, as depicted in FIG. 2A, was then freeze-dried to minimize re-stacking of the GO sheets. The Co-NG catalyst was finally obtained by heating the dried sample under a NH₃ atmosphere to dope the GO with nitrogen. Control samples of nitrogen-doped graphene (NG) and Co-containing graphene (Co-G, with no N doping) were also prepared. A detailed preparation procedure is described in Example 1.6.

The morphology of the Co-NG was examined by scanning electron microscopy (SEM). FIG. 2B reveals that the Co-NG has similar morphologic features to graphene with sheet-like structures. Transmission electron microscopy (TEM) (FIG. 2C) shows Co-NG nanosheets with ripples observed on the surface. No cobalt-derived particles were found by SEM or TEM on the Co-NG nanosheets, underscoring the smallness in size of the Co. The Co-NG could be formed into a paper by filtration of Co-containing GO suspension and subsequent NH₃ treatment (FIG. 2D).

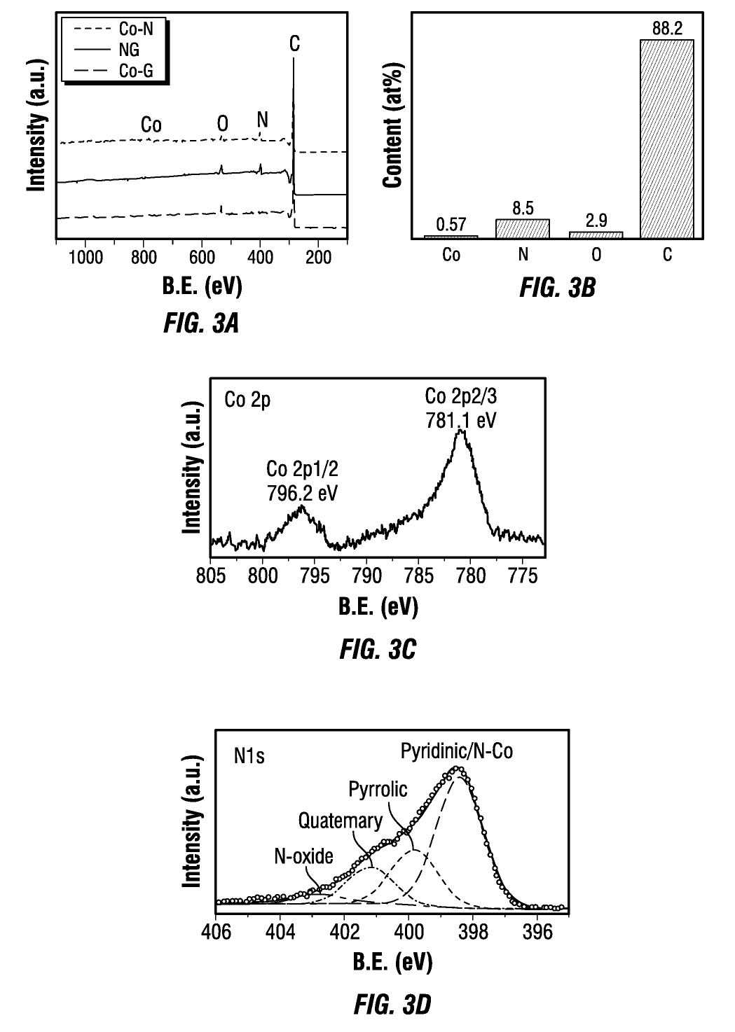

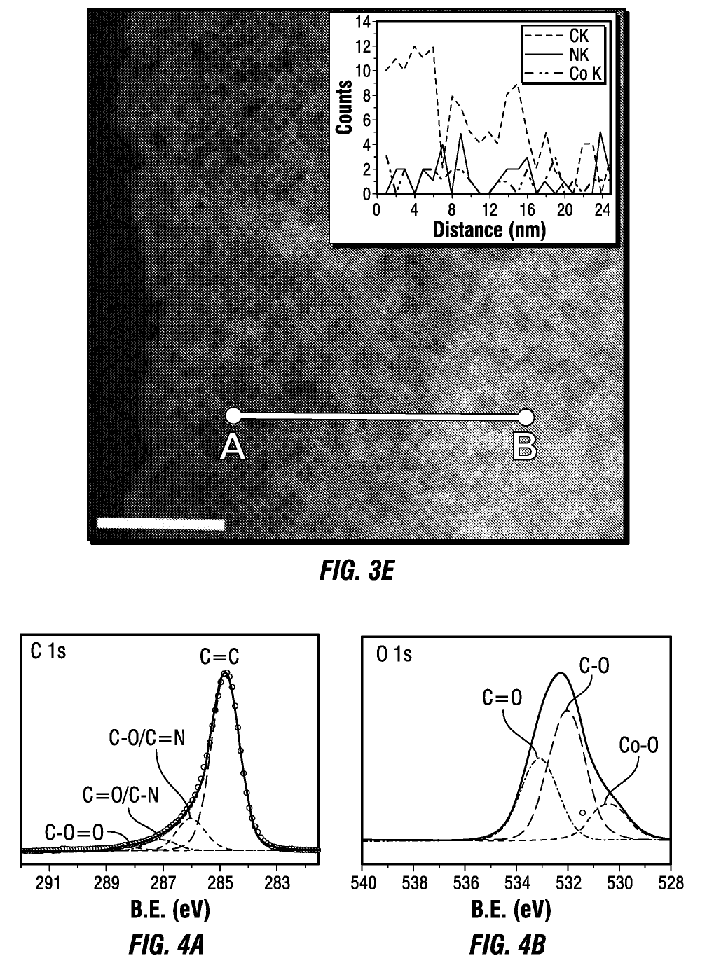

To probe the compositions of Co-NG, X-ray photoelectron spectroscopy (XPS) (FIG. 3A) showed the presence of C, N, and O peaks in the samples of Co-NG and NG, while the N peak was absent in Co-G. No significant signals were found at the Co region in the Co-NG.

To determine the Co content, inductively coupled plasma optical emission spectrometry (ICP-OES) was performed after digesting the powdered sample in HNO₃. By combined use of XPS and ICP-OES, the Co-NG was determined to be 0.57 at % Co, 8.5 at % N, 2.9 at % 0 and 88.2 at % C, as summarized in FIG. 3B. The Co content in NG with no intentional addition of Co is negligible (<0.005 at % by ICP-OES). The XPS detailed scan in the Co region (FIG. 3C) of Co-NG shows two peaks at a binding energy of 781.1 eV and 796.2 eV, corresponding to the 2p_{3/2} and 2p_{1/2} levels, respectively. The peak positions and the separation of 15.1 eV between these two peaks indicates the presence of Co(III). The N is (FIG. 3D) can be deconvoluted into different types of nitrogen, namely pyridinic and N—Co (398.4 eV), pyrrolic (399.8 eV), graphitic (401.2 eV), and N-oxide (402.8). The small difference in the binding energies between pyridinic N and N—Co prevents further deconvolution.

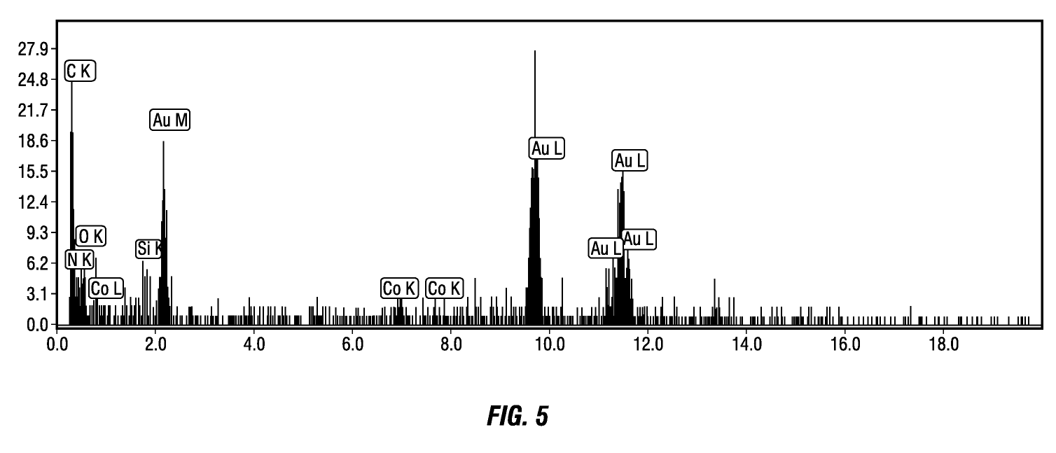

From the peak intensity, the N was dominated by the pyridinic/N—Co species. The C 1s and O 1s XPS are shown in FIG. 4. The presence of Co and N was further confirmed by the energy-dispersive X-ray spectroscopy (EDS) spectrum (FIG. 5) taken in the area shown in FIG. 3E of the scanning transmission electron microscopy (STEM) image. The EDS line scan in FIG. 3E reveals the close-proximity distributions of the Co and N elements.

### Example 1.2. Atomic Structure Analysis by HAADF and EXAFS

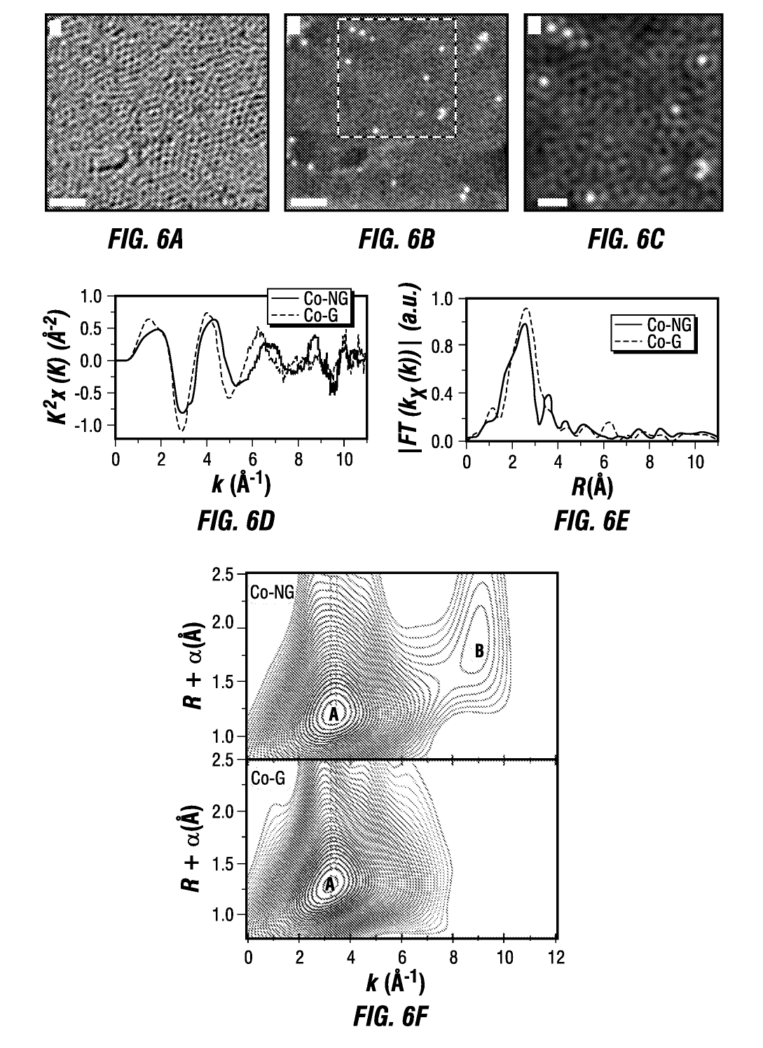

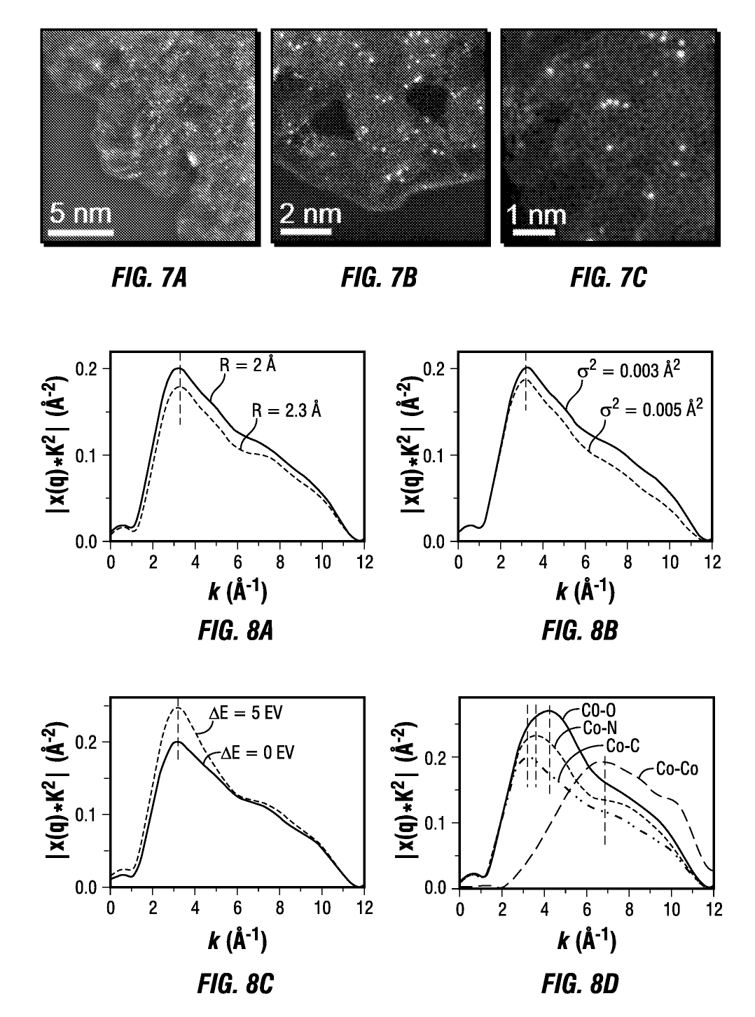

To investigate the atomic structure of the Co-NG nanosheet, Applicants used high-angle annular dark field (HAADF) imaging in an aberration-corrected STEM. The bright-field STEM image (FIG. 6A) shows the defective structures of the GO-derived graphitic carbon. The corresponding HAADF image (FIG. 6B) clearly shows that several bright dots, corresponding to heavy atoms (Co in this case), are well dispersed in the carbon matrix. The size of these dots is in the range of 2 Å to 3 Å, indicating that each bright dot corresponds to one individual Co atom. The enlarged view of the selected region (FIG. 6C) reveals that each Co atom is centered by the light elements (C, N, and/or O). Additional STEM images are provided in FIG. 7.

To probe the possible bonding between the cobalt and the light elements in the Co-NG, Applicants performed extended X-ray absorption fine structure (EXAFS) analysis at the Co K-edge, using both a wavelet transform (WT) and Fourier transform (FT). WT-EXAFS analysis is a powerful method for separating backscattering atoms that provides not only a radial distance resolution, but also resolution in the k-space. The discrimination of atoms can be identified even when these atoms overlap substantially in R-space. The k²-weighted χ(k) signals (FIG. 6D) and the corresponding FTs (FIG. 6E) of the Co-NG and Co-G samples show quite similar profiles, suggesting no substantial differences in the coordination environments of the Co atoms.

The existence of only one single strong shell, shown at ˜1.5 Å in R-space (FIG. 6E), is usually indicative of amorphous or poorly crystalline materials. The aforementioned observation is also indicative of a large structural disorder around Co sites, consistent with the abundant misplacement and voids observed in the aberration-corrected STEM images.

FIG. 6F shows the WT contour plots of the two signals based on Morlet wavelets (κ=3, σ=1) with optimum resolution at the first shell. The intensity maximum A is well-resolved for the Co-NG (3.4 Å⁻¹) and Co-G (3.2 Å⁻¹). Since the locations of the WT maxima are highly predictable, they allow qualitative interpretation of the scattering paths origins. The WT maximum is known to be affected by the path length R, Debye-Waller factors σ², energy shift ΔE and atomic number Z, and this corresponds to the same location of the maximum in the q-space magnitude.

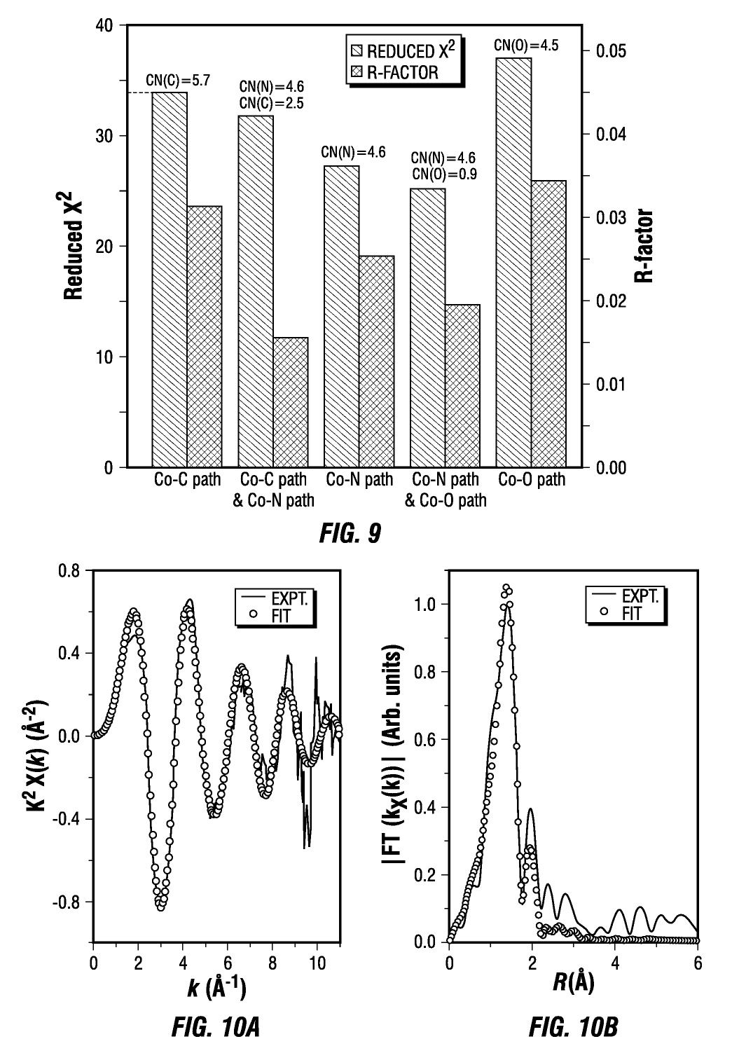

For an isolated Co—C path (R=2 Å), the WT maximum at 3.2 Å⁻¹ in the q-space magnitude showed little dependence on R, σ², and ΔE, but it is largely affected by different Z (3.5 Å⁻¹ for Co—N path, 4.3 Å⁻¹ for Co—O path, and 6.8 Å⁻¹ for Co—Co path) (FIG. 8). As a result, by comparison, the WT maximum A at 3.2 Å⁻¹ for the Co-G can be associated with the Co—C path, and 3.4 Å⁻¹ for the Co—N path within the Co-NG. A small difference of ˜0.1 Å⁻¹ between the maxima A for the Co-NG (3.4 Å⁻¹) and the calculated Co—N path (3.5 Å⁻¹) might arise from the much shorter length of the actual Co—N path than 2 Å. The maximum feature B at 9.0 Å⁻¹ might result from the effect of side lobes and the multiple scattering paths between the light atoms, instead of from the Co—Co path which exhibits a maximum at 6.8 Å⁻¹. The validity of the above WT-EXAFS interpretation was confirmed by a least-squares curve fitting analysis carried out for the first coordination shell of Co (FIGS. 9-10 and Example 1.9).

Taken together, the data indicate that, in the Co-NG, the Co is atomically dispersed in the nitrogen-doped graphene matrix and it is in the ionic state with nitrogen atoms in the cobalt's first coordination sphere. Hence, nitrogen doping of the graphene provides sites for Co incorporation.

### Example 1.3. HER Activity Evaluation

The HER catalytic activity of the Co-NG was evaluated using a standard three-electrode electrochemical cell. The catalyst mass loading on a glassy carbon electrode was 285 μg cm⁻². FIG. 11A shows the linear-sweep voltammograms (LSV) at a scan rate of 2 mV s⁻¹ in 0.5 M H₂SO₄ after iR-compensation for the Co-NG electrode along with the two control samples of NG and Co-G. The commercial Pt/C (20 wt % platinum on Vulcan carbon black, Alfa Aesar) with the same mass loading was also included as a reference point.

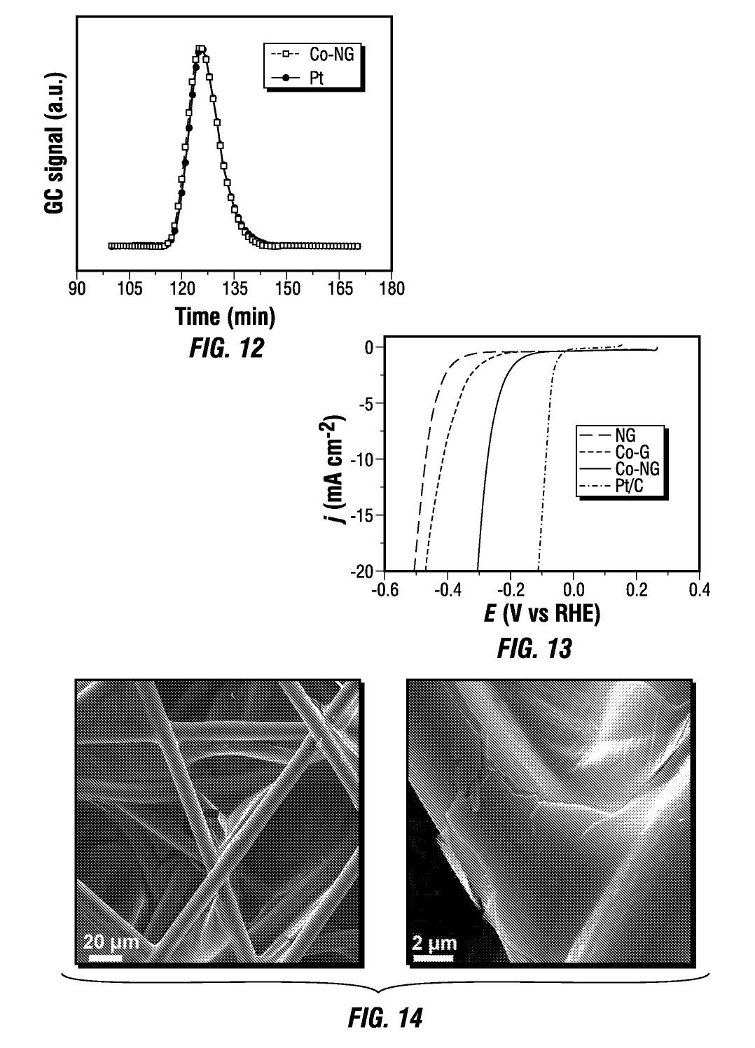

As expected, the Pt/C exhibits good HER catalytic activity with a near zero onset η. The Co-NG catalyst shows optimal HER activity, as evidenced by the very small onset η of ˜30 mV (inset in FIG. 11A), beyond which the current density increases sharply. The onset η is defined here as the potential at a current density of −0.3 mA cm⁻², which is chosen to match the onset η determined by the Tafel plot (shown later). The η needed to deliver 1 mA cm⁻² and 10 mA cm⁻² were determined to be ˜70 mV and ˜147 mV, respectively. The Faradaic efficiency of the Co-NG catalyst was determined to be ˜100% by gas chromatography (FIGS. 11B and 12; Example 1.10), confirming the cathode current is due to the generation of H₂.

Applicants note that the aforementioned η values are much smaller than those of Co-based molecular complexes. Such observations suggest that the Co-NG system is an optimal solid-state earth-abundant catalyst. Moreover, the CO-NG system shows much higher activity than all the recently reported metal-free catalysts (Table 1 and Example 1.11).

TABLE 1
Collected data of HER activity in acidic electrolyte solutions.

| | | | η (mV) |
|---|---|---|---|
| | Loading | | @10 |
| Catalyst | (mg cm⁻²) | Electrolyte | mA cm⁻² |
| Co-NG | 0.285 | 0.5M H₂SO₄ | 147 |
| [Mo₃S₁₃]²⁻ clusters | 0.1 | 0.5M H₂SO₄ | 180 |
| MoS₂/RGO | 0.285 | 0.5M H₂SO₄ | 150 |
| Defect-rich MoS₂ | 0.285 | 0.5M H₂SO₄ | 190 |
| Oxygen-incorporated MoS₂ | 0.285 | 0.5M H₂SO₄ | 160 |
| Double gyroid MoS₂ | 0.06 | 0.5M H₂SO₄ | 206 |
| MoSₓ\|N-CNT | N/A | 0.5M H₂SO₄ | 110 |
| 1T MoS₂ | 0.05 | 0.5M H₂SO₄ | 207 |
| Electrodeposited amorp. MoS₃ | N/A | 1M H₂SO₄ | 242 |
| Wet-chemical amorp. MoSₓ | N/A | 0.5M H₂SO₄ | 200 |
| WS₂ nanoflakes | 0.35 | 0.5M H₂SO₄ | 170 |
| WS₂/rGO | 0.4 | 0.5M H₂SO₄ | ~280 |
| 1T WS₂ | ~0.0002 | 0.5M H₂SO₄ | 200 |
| CoP nanoparticles on CNT | 0.285 | 0.5M H₂SO₄ | 122 |
| CoP nanoparticles | 2 | 0.5M H₂SO₄ | ~75 |
| MoP nanoparticles | 0.36 | 0.5M H₂SO₄ | 125 |
| MoS\|P | 1 | 0.5M H₂SO₄ | 81 |
| Ni₂P nanoparticles | 1 | 0.5M H₂SO₄ | ~100 |
| MoB | 2.5 | 1M H₂SO₄ | 215 |
| Mo₂C | 1.4 | 1M H₂SO₄ | 215 |
| Co-NRCNTs | 0.28 | 0.5M H₂SO₄ | 260 |
| FeCo@NCNTs-NH | 0.32 | 0.5M H₂SO₄ | 290 |
| N- and P-doped graphene | 0.2 | 0.5M H₂SO₄ | 422 |
| C₃N₄@NG | 0.1 | 0.5M H₂SO₄ | 240 |
| C₃N₄ nanoribbons on graphene | 0.143 | 0.5M H₂SO₄ | 207 |
| N- and S-doped graphene | N/A | 0.5M H₂SO₄ | 276 |
| N-doped mesoporous graphene | 0.57 | 0.5M H₂SO₄ | 239 |

As control samples, the NG and Co-G show poor activity towards HER with onset η larger than 200 mV, indicating that the active sites in Co-NG are associated with the Co and N. Tafel analysis (FIG. 11C) gives Tafel slope values of 31, 82, 117 and 144 mV decade⁻¹ for Pt/C, Co-NG, NG and Co-G, respectively. Notably, the Tafel plot for the Co-NG catalyst becomes linear at an η value of about 30 mV.

When tested in alkaline media (1 M NaOH), the Co-NG catalyst also exhibits improved activity compared to the NG and Co-G (FIG. 13 and Example 1.12). This distinguishes the Co-NG catalyst from the MoS₂ and some metal phosphide (e.g. Ni₂P) catalysts, which are highly active in acid, but are unstable in base, thereby making their application in alkaline electrolysis limited.

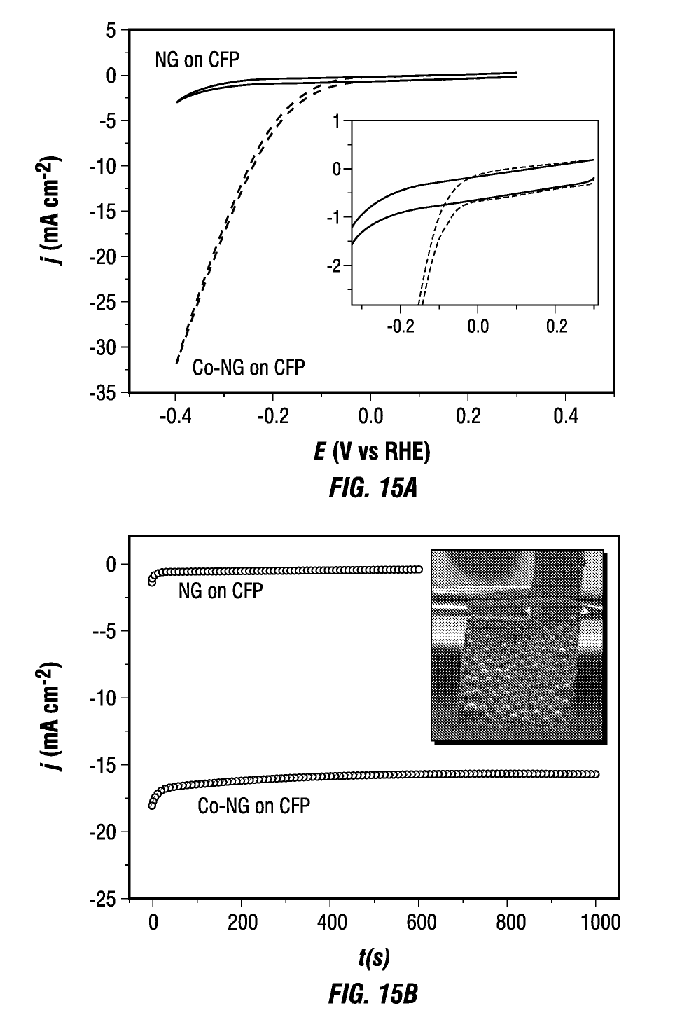

Moreover, as the precursor suspension of GO containing small amounts of Co is highly stable, it can be formed into a paper (FIG. 2D), which can work as a free-standing electrode for H₂ generation. Alternatively, the precursor solution can be readily coated onto a conductive substrate (FIG. 14 and Example 1.13) that can be used as a binder-free electrode (FIG. 15) after post-annealing in NH₃. The straightforward and convenient synthetic approach to achieve the Co-NG catalyst adds versatility in the design and construction of electrodes and thus enables easy integration of the catalytic layer with other components in electrochemical devices.

### Example 1.4. Effects of Co and N on Co-NG Catalytic Activity

To investigate the effects of Co content on the catalytic activity, Co-NG catalysts with different Co content (from 0.03 at % to 1.23 at %, Table 2 and Example 1.14) were prepared and their HER activity were evaluated by LSV.

TABLE 2
Elemental compositions of the samples with different
Co contents prepared by varying the volume of CoCl₂
solution added into the GO precursor solution.

| | CoCl₂ | Co | Co | C | | |
|---|---|---|---|---|---|---|
| Sample | (μL) | (wt %) | (at %) | (at %) | N (at %) | O (at %) |
| NG | 0 | 0.0171 | <0.005 | 89.2 | 7.1 | 3.7 |
| Co-NG1 | 50 | 0.1356 | 0.03 | 88.9 | 6.5 | 4.5 |
| Co-NG2 | 150 | 0.4413 | 0.09 | 87.6 | 7.2 | 4.8 |
| Co-NG3 | 500 | 1.3238 | 0.29 | 87.1 | 8.0 | 4.7 |
| Co-NG4 | 1000 | 2.4806 | 0.57 | 88.1 | 8.5 | 2.9 |
| Co-NG5 | 2000 | 4.9032 | 1.23 | 81.3 | 7.4 | 10.1 |

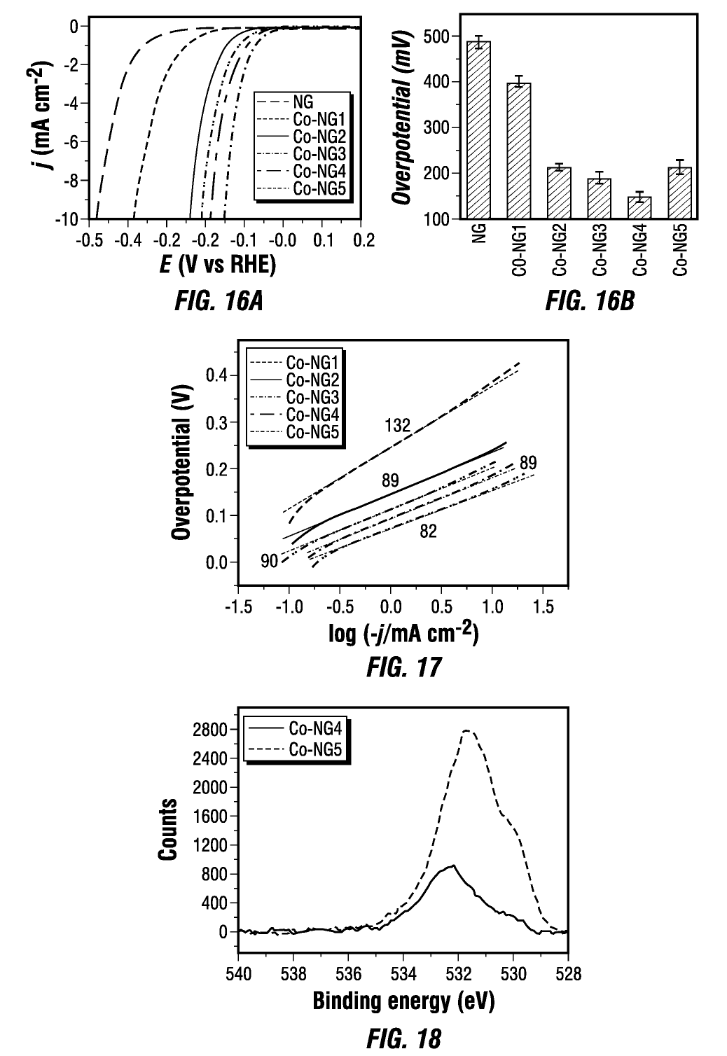

The results (FIGS. 16-17) show that HER activity does not increase linearly with the Co content, but instead there is a saturation point for Co content, beyond which the HER activity starts to decrease. Without being bound by theory, it is envisioned that the aforementioned trend may be due to excess Co content. For instance, the extra Co atoms may not be able to be incorporated into the C—N lattices in the graphene. Instead, the excessive Co would form Co-containing particles or clusters, such as cobalt oxide, as evidenced by the much higher oxygen content in the Co-NG sample with the highest Co content (Table 2 and FIG. 18).

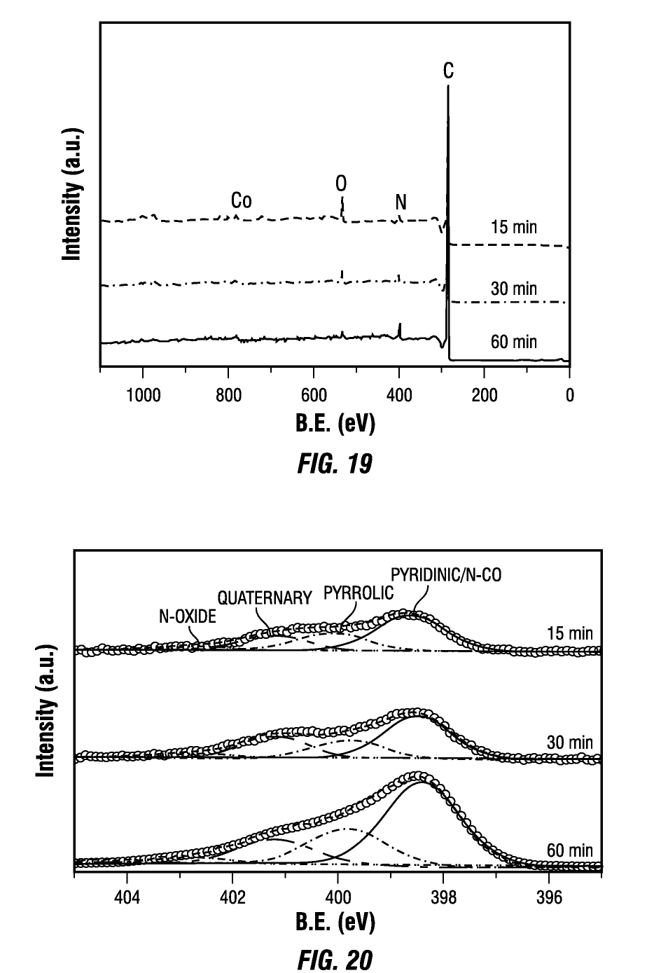

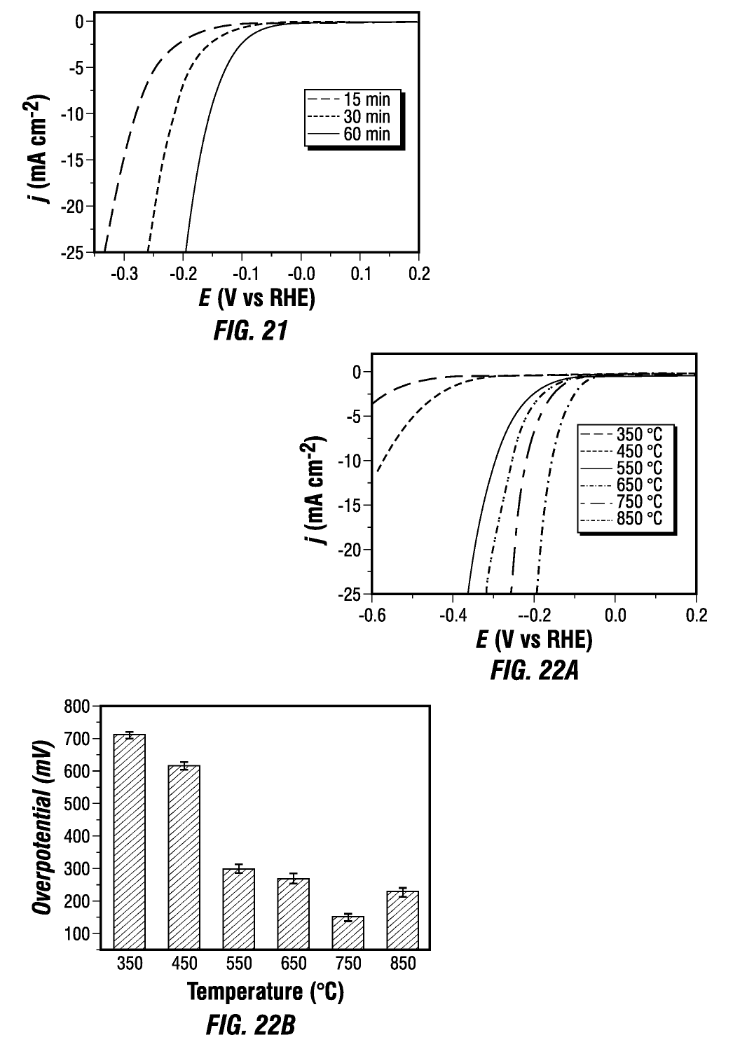

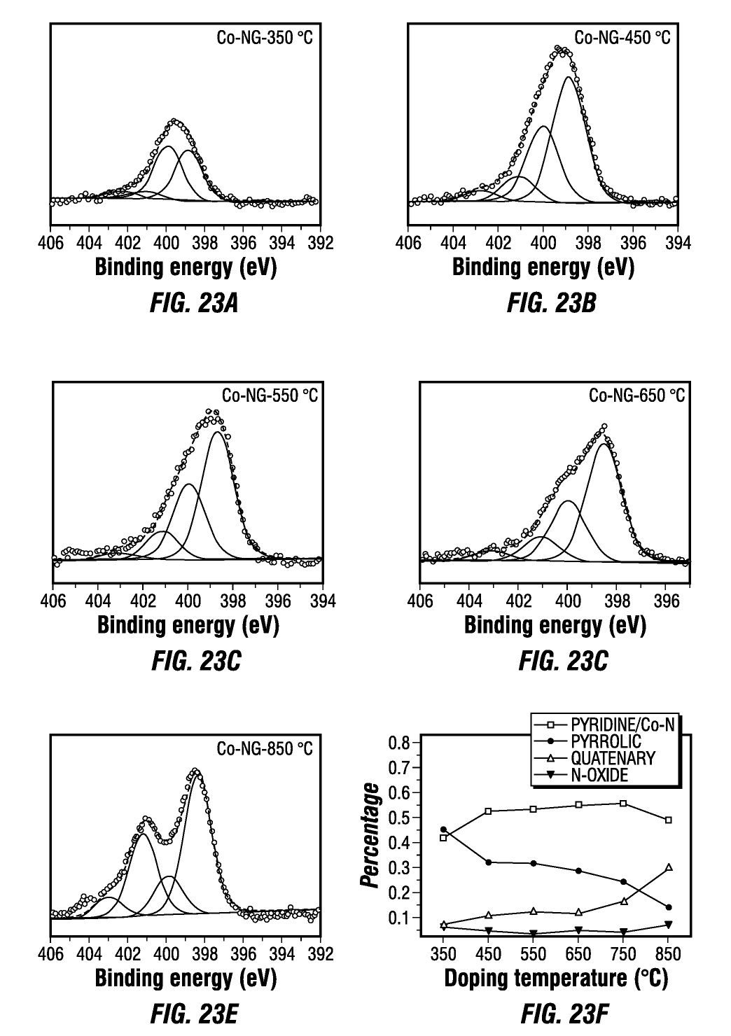

To study the effects of nitrogen doping level on the HER activity, samples with different N doping concentration were prepared by varying the annealing time (FIGS. 19-20). The electrochemical measurements (FIG. 21 and Example 1.15) show that higher N doping level results in higher HER activity, suggesting the important role of nitrogen in forming the catalytically active site. The influence of nitrogen doping temperature on HER activity was also studied. The results (FIG. 22 and Example 1.16) show that doping temperature above 550° C. is necessary to observe appreciably improved HER activity, which implies that the high temperature was necessary to induce Co—N interaction and thus to create Co—N active sites. The optimized doping temperature was 750° C. with the highest N doping level (Table 3 and FIG. 23). These optimizations further suggest that the HER active sites involve the coupling effects between Co and N.

TABLE 3
Elemental compositions of the samples annealed at different temperatures.

| Temperature (° C.) | C (at %) | N (at %) | O (at %) |
|---|---|---|---|
| 350 | 82.6 | 3.1 | 14.3 |
| 450 | 84.9 | 5.3 | 9.8 |
| 550 | 85.8 | 7.0 | 7.2 |
| 650 | 88.1 | 7.9 | 4.0 |
| 750 | 88.6 | 8.5 | 2.9 |
| 850 | 92.3 | 4.3 | 3.4 |

An important parameter to evaluate in the intrinsic activity of a catalyst is its turnover frequency (TOF), which gives its activity on a per-site basis. To quantify the number of active sites in Co-NG, each Co center is considered to account for one active site (see Example 1.17). The contribution from the C—N matrix can be ignored as the exchange current density (i₀), determined from the Tafel plot by an extrapolation method, for the NG (8.34×10⁻⁷ A cm⁻²) is much smaller than that of the Co-NG (1.25×10⁻⁴ A cm⁻²). FIG. 11D shows the TOF values for the Co-NG catalyst against applied η together with those of eight recently reported non-precious-metal HER catalyst at specific η, including UHV-deposited MoS₂ nanocrystals on an Au substrate, [Mo₃S₁₃]²⁻ nanoclusters supported on graphite paper, amorphous MoS₃, Ni—Mo nanopowders, Ni₂P, CoP, MoP, and MoP|S nanoparticles.

At η of 50 mV, 100 mV, 150 mV and 200 mV, the TOF values of the Co-NG are 0.022 H₂ s⁻¹, 0.101 H₂ s⁻¹, 0.386 H₂ s⁻¹ and 1.189 H₂ s⁻¹, respectively. These values reveal that the Co-NG is higher than or similar in activity to other reported catalysts, apart from the UHV-deposited MoS₂ nanocrystals and the [Mo₃S₁₃]²⁻ nanoclusters. The TOF value of the Co-NG at thermodynamic potential (0 V vs RHE) was also calculated using the exchange current density, which gives a TOF value of 0.0054 H₂ s⁻¹. This value is approximately three times smaller than that (0.0164 H₂ s⁻¹) of the UHV-deposited MoS₂ nanocrystals (the benchmark catalyst on MoS₂). However, it should be noted that, unlike the active site selectivity on the edge sites for MoS₂ and on the surface sites for nanoparticulate catalysts (including the amorphous MoS₃, Ni—Mo nanopowders, Ni₂P, CoP, MoP and MoP|S), each Co center in Applicants' Co-NG is presumably catalytically active.

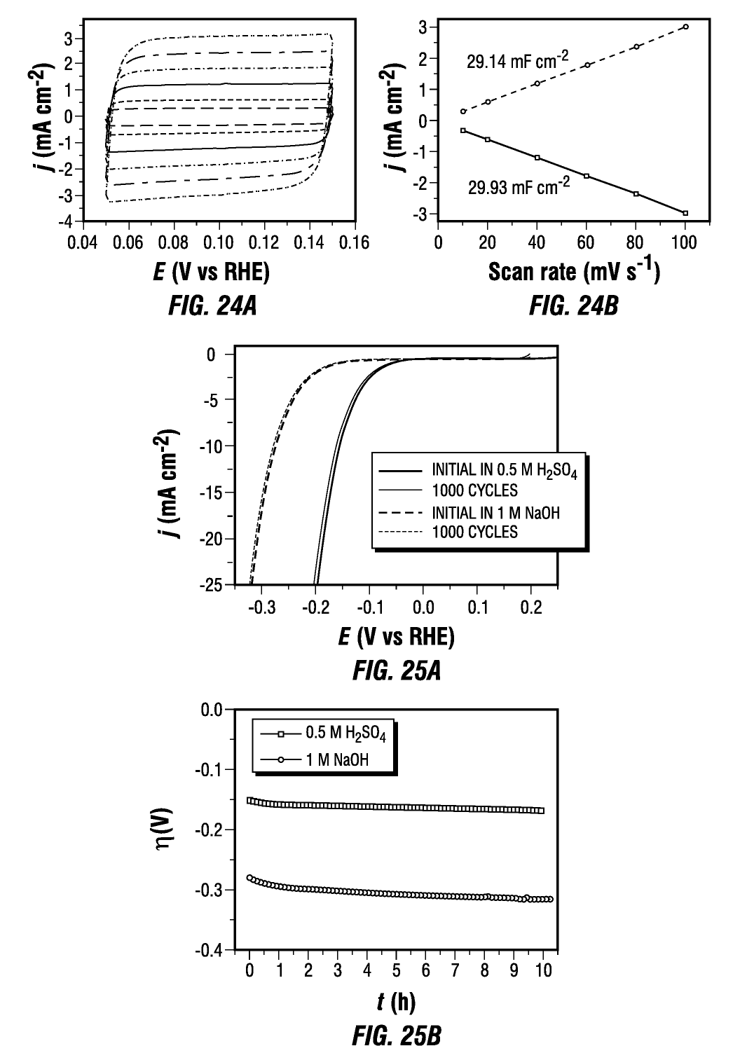

To estimate the active site density (sites per cm²), the electrochemically active surface areas (ECSA) were measured (FIG. 24), which yields an active site density of ˜9.7×10¹³ sites cm⁻² (see Example 1.18). For comparison, Pt(111) has an active site density¹⁰ of 1.5×10¹⁵ sites cm⁻².

To evaluate the stability of the Co-NG catalyst, accelerated degradation studies were performed in both acid and base. As shown in FIG. 25A, the cathodic polarization curves obtained after 1000 continuous cyclic voltammograms (scan rate: 50 mV s⁻¹) shows a negligible decrease in current density compared to the initial curve, indicating the excellent stability of Co-NG in both the acid and base. In addition to the cycling tests, galvanostatic measurements at a current density of 10 mA cm⁻² were performed and the results (FIG. 25B) show that after 10 hours of continuous operation, the η increased by 35 mV in acid and 17 mV in base, which might be associated with the desorption of some catalysts from the glassy carbon substrate during operation.

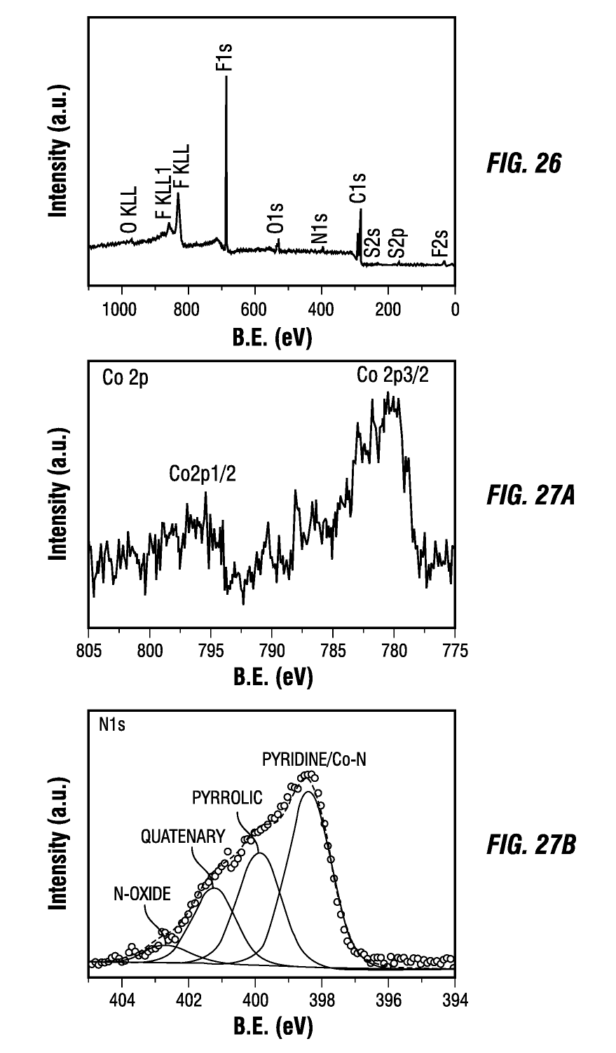

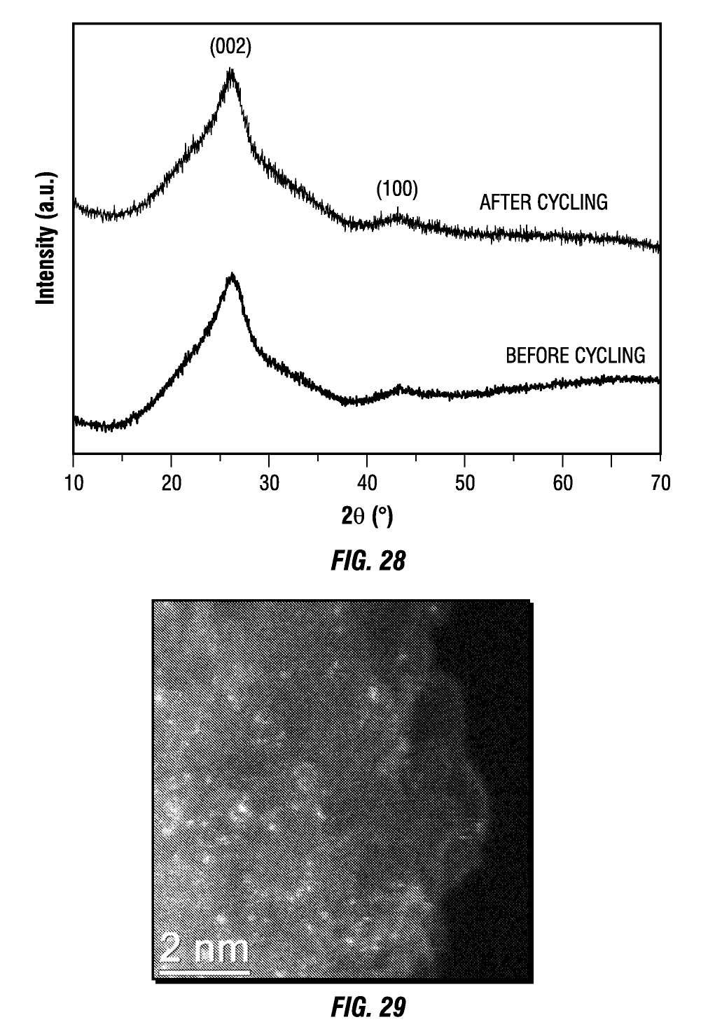

The catalysts after accelerated cycling were characterized by XPS (FIGS. 26-27), X-ray diffraction (XRD) analysis (FIG. 28) and HAADF-STEM (FIG. 29), which suggest that cycling operation did not change the atomic Co dispersion and the chemical states of Co and N (see Example 1.19). The optimal stability of the Co-NG with active sites at the atomic scale can be attributed to the high-temperature-induced strong coordination between the Co and N.

### Example 1.5. Materials Synthesis

All chemicals were purchased from Sigma-Aldrich unless otherwise specified. Graphene oxide (GO) was synthesized from graphite flakes (˜150 μm flakes) using the improved Hummers method (ACS Nano 4, 4806-4814 (2010)).

### Example 1.6. Synthesis of Co-NG

An aqueous suspension of GO (2 mg mL⁻¹) was first prepared by adding 100 mg GO into 50 mL of DI water and sonicating (Cole Parmer, model 08849-00) for 2 hours. 1 mL of a CoCl₂.6H₂O (3 mg mL⁻¹) aqueous solution was added into the GO suspension and sonicated for another 10 minutes. This precursor solution was freeze-dried for at least 24 hours to produce a brownish powder.

The dried sample was then placed in the center of a standard 1-inch quartz tube furnace. After pumping and purging the system with Ar three times, the temperature was ramped at 20° C. min⁻¹ up to 750° C. with the feeding of Ar (150 sccm) and NH₃ (50 sccm) at ambient pressure. The reaction was allowed to proceed for 1 hour and the final product Co-NG with a blackish color was obtained after the furnace was permitted to cool to room temperature under Ar protection. The control sample of Co-G was prepared with the same treatment except NH₃ was not introduced during the annealing process. The control sample of NG was prepared with the same treatment except that the CoCl₂.6H₂O was not added into the precursor solution. The Co-NG paper was fabricated by first filtering a 25 mL precursor solution (2 mg mL⁻¹ GO and 0.06 mg mL⁻¹ CoCl_{z}.6H₂O) through a 0.22 μm polytetrafluoroethylene membrane (Whatman). After peeling off the paper from the membrane, the cobalt-containing GO paper was annealed at 750° C. for 1 hour under Ar (150 sccm) and NH₃ (50 sccm) atmosphere in a tube furnace.

### Example 1.7. Characterizations

A JEOL 6500F SEM was used to examine the sample morphology. A JEOL 2100 field emission gun TEM was used to observe the morphologic and structural characteristics of the samples. Aberration-corrected scanning TEM images were taken using an 80 KeV JEOL ARM200F equipped with a spherical aberration corrector.

Chemical compositions and elemental oxidation states of the samples were investigated by XPS spectra with a base pressure of 5×10⁻⁹ Torr. The survey spectra were recorded in a 0.5 eV step size with a pass energy of 140 eV. Detailed scans were recorded in 0.1 eV step sizes with a pass energy of 140 eV. The elemental spectra were all corrected with respect to C1s peaks at 284.8 eV. Cobalt quantitative analysis was carried using a PerkinElmer Optima 4300 DV ICP-OES. X-ray diffraction (XRD) analysis was performed by a Rigaku D/Max Ultima II (Rigaku Corporation, Japan) configured with a CuKα radiation, graphite monoichrometer, and scintillation counter. The Co K-edge EXAFS spectra were acquired at beamline 1W2B of the Beijing Synchrotron Radiation Facility (BSRF) in fluorescence mode using a fixed-exit Si(111) double crystal monochromator. The incident X-ray beam was monitored by an ionization chamber filled with N₂, and the X-ray fluorescence detection was performed using a Lytle-type detector filled with Ar. The EXAFS raw data were then background-subtracted, normalized and Fourier transformed by the standard procedures with the IFEFFIT package.

### Example 1.8. Electrochemical Measurements

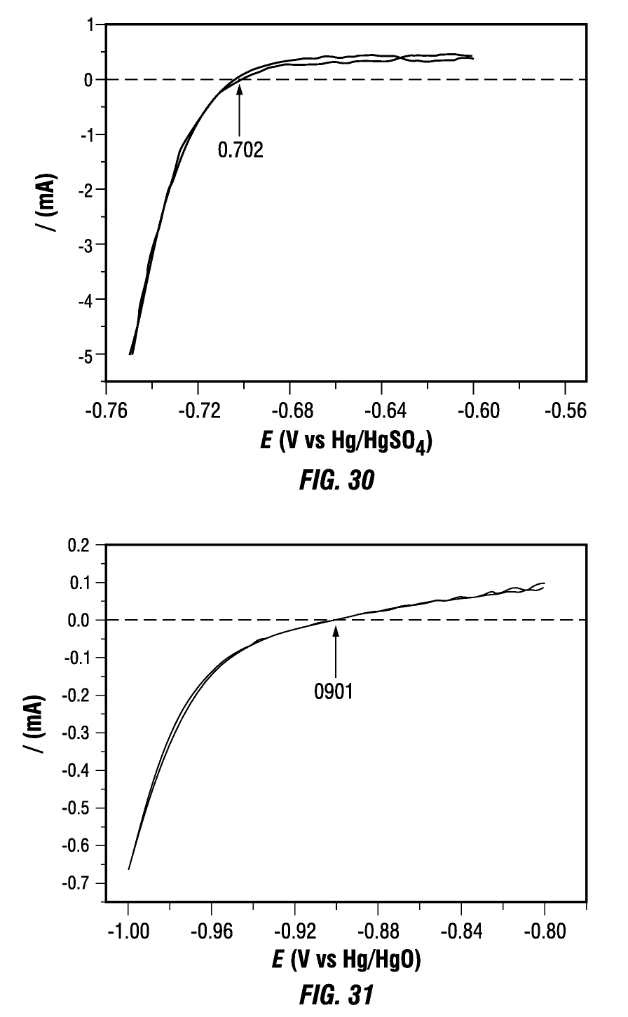

The electrochemical measurements were carried out in a three-electrode set-up using a CHI 608D workstation (US version). To prepare the working electrode, 4 mg of the catalyst and 80 μL of 5 wt % Nafion solution were dispersed in 1 mL of 4:1 v/v water/ethanol with 1 to 2 hour bath-sonication (Cole Parmer, model 08849-00) to form a homogeneous suspension. 5 μL of the catalyst suspension was loaded onto a 3 mm-diameter glassy carbon electrode (mass loading ˜0.285 mg cm⁻²). For the counter electrode, a Pt wire was used. The reference electrode was Hg/HgSO₄,K₂SO₄(sat) for measurements in 0.5 M H₂SO₄, and Hg/HgO,NaOH (1 M) for measurements in 1 M NaOH. Both of these two reference electrodes were calibrated against a reversible hydrogen electrode (RHE) under the same testing conditions immediately before the catalytic characterizations (FIGS. 30-31 and Example 1.20). A scan rate of 2 mV s⁻¹ was used in the cyclic voltammograms of the HER activity unless otherwise noted. The electrolyte solution was sparged with H₂ for 20 minutes before each test.

### Example 1.9. Least-Squares Curve Fitting Analysis on EXAFS Measurements

To examine the validity of the above WT-EXAFS interpretation, a least-squares curve fitting analysis was carried out for the first coordination shell spreading from 0.8 to 2.5 Å. All backscattering paths were calculated based on the structures provided by ab initio simulations. The amplitude reduction factor (S₀²) was fixed at 0.96. The energy shift (ΔE₀) was constrained to be the same for all scatters. The path length R, coordination number (CN), and Debye-Waller factors σ² were left as free parameters. The fit was done in R space with k range of 1.5-10.5 Å⁻¹ and k² weight. Five structural models, i.e., the pure Co—C path, a mixture of Co—C and Co—N paths, pure Co—N path, a mixture of Co—N and Co—O paths, and pure Co—O path, were used to describe the local structure of the Co-NG. Both reduced χ² and R-factor were used as relevant parameters to determine the goodness-of-fit. As shown in FIG. 9, a mixture of Co—N and Co—O coordinations with CN(N)=4.6 and CN(O)=0.9 provides the best fit, in good agreement with the results obtained by WT-EXAFS analysis.

A comparison between the experimental spectrum and the best-fit result is shown in FIG. 10. Thus, it can be concluded that the Co atoms in the Co-NG are preferentially bonded to the nitrogen atoms. Moreover, the Co atoms adopt a higher coordination number with nitrogen than the Fe—N bonding in a previously reported carbon nanotube-graphene complex, which has a Fe—N/O coordination number of 3.3-3.6.¹

### Example 1.10. Faradaic Efficiency Measurements

To measure the Faradaic efficiency of the Co-NG catalyst, H₂ production was performed in a closed pyrex glass reactor at a constant cathodic current density of 20 mA cm⁻². Continuous gas flow inside the whole reaction line was maintained by using a circulation pump. Quantitative analysis of produced H₂ was measured by gas chromatography (GC) (GOW-MAC 350) using a thermal conductivity detector (TCD). A defined amount of sampling gas was injected into the GC using a 6-port injection valve. The plot in FIG. 11B shows a good correlation between the calculated and measured amounts of H₂ gas, indicating near 100% efficiency. The production of H₂ gas was further confirmed by comparison of the GC signals of H₂ from the Co-NG and a Pt wire working electrode, which shows almost the same H₂ production activity after the same reaction time period (FIG. 12).

### Example 1.11. Activity Comparisons to Other Reported HER Electrocatalysts in Acid

To compare the HER activities of the Co-NG catalyst with other reported non-precious-metal catalysts and metal-free catalysts, Applicants chose the overpotential required to deliver current density of 10 mA cm⁻² (η@10 mA cm⁻²) as the main parameter for comparison. Though the onset η is a good indicator on the intrinsic activity, it was not used here for comparison because of the ambiguity in determining its value. The summarized comparison data was shown in Table 1. The activity of the Co-NG is higher than most of the Mo-based and other transition-metal based catalysts as well as all the metal-free catalysts, but slightly lower than the metal phosphide catalysts, taking the catalyst mass loadings into considerations.

### Example 1.12. HER Activity in Alkaline Electrolyte

The HER activity of the Co-NG catalyst was tested in 1 M NaOH electrolyte. The control samples of Co-G and NG were also tested under the same conditions. The commercial Pt/C was included as a reference point. The testing results (FIG. 13) show that the Co-NG has a much higher HER activity with a more positive onset η and a larger current density compared to the Co-G and NG. The activity trend of these four samples in alkaline condition is the same as that in acid. η of ˜170 mV and ˜270 mV are needed for the Co-NG to deliver 1 mA cm⁻² and 10 mA cm⁻², respectively.

### Example 1.13. Co-NG Catalysts on Carbon Fiber Paper

Due to the very low content of Co, the Co-containing precursor solution, shown in FIG. 2A, can form a stable suspension similar to the pure GO solution. Benefited from this feature, the precursor solution can be easily coated on conductive substrates by straightforward methods, such as drop-coating, dip-coating or spin-coating. The coated substrates, after post-annealing treatment, can be directly used as a highly active HER electrode without using any binder. As a proof of concept, 50 μL Co-containing GO precursor solution was drop-cast onto a carbon fiber paper (CFP, from Fuel Cell Store, 2050-A) in a defined area (1×1 cm²). This gives a precursor loading of ˜100 μg cm⁻². The Co-NG on CFP was obtained by annealing the coated CFP under NH₃ atmosphere at 750° C. for 1 hour (same procedure as used for the preparation of Co-NG catalyst in powder form). The active material Co-NG mass loading was estimated to be ˜40 μg cm⁻², assuming 60 wt % loss from the GO due to thermal reduction based on the observation during preparation of the powder-form of the Co-NG catalyst.

FIG. 14 shows SEM images of the Co-NG on CFP, which shows that the CFP is surface-wrapped with Co-NG flakes and they are in good physical contact. The Co-NG on CFP was then directly used as a working electrode for HER testing. For comparison, NG on a CFP electrode was also tested. The CV curves (FIG. 15A) show that Co-NG on CFP has a much higher HER activity with larger current density and more positive onset η than the NG on CFP. These observations are consistent with those for powder-form catalysts, indicating the generality in preparing the Co-NG catalyst.

FIG. 15B shows the current density versus time response at a constant η of 300 mV. The Co-NG on CFP delivers a stable current during the testing period, indicating a good adhesion of the Co-NG flakes on the CFP. The initial loss of current density results from the accumulation of H₂ bubbles on the electrode, blocking some active sites. The inset photograph (taken after a 30 s chronoamperometry measurement) shows that the Co-NG on CFP electrode is covered fully with evolved H₂ bubbles. In comparison, the bubbles can be barely seen in the NG on CFP electrode (not shown) during the same time period.

### Example 1.14. Co Contents on the Influence of the HER Activity of Co-NG

To investigate the influence of Co content on the HER activity, the Co-NG catalysts with different Co content were prepared by varying the amount of CoCl₂ added into the precursor solution, with all the other synthetic treatments kept the same. The elemental compositions of the corresponding samples were summarized in Table 2. The Co contents were determined by ICP-OES, and the C, N and O contents were determined by XPS. It can be seen that the Co content in the NG sample without intentionally adding Co is negligible (<0.005 at %). The Co contents, as expected, increase linearly with the amount of CoCl₂ solution added. The N doping contents are in a similar range (˜6 to ˜8 at %) in these samples. The O contents are in the range of ˜3 to ˜5 at % in all the samples except for the sample Co-NG5 with the largest amount of Co, which has much higher O content of ˜10 at %.

FIG. 18 shows the O1s XPS peak of the Co-NG4 and Co-NG5. Compared to the Co-NG4, the O1s peak for Co-NG5 has large portions from a lower binding energy that can be assigned to metal oxide, which indicates the formation of cobalt oxide particles or clusters in the Co-NG5.

The HER activity of these samples were investigated in 0.5 M H₂SO₄. FIG. 16A shows the LSV polarization curves of the corresponding samples in Table 2. The results show that all the samples with the adding of Co have higher HER activity than bare NG. Co content as low as 0.09 at % (Co-NG2) is already sufficient to significantly increase the HER activity compared to NG. The activity increase continues up to 0.57 at % Co (Co-NG4), after which the activity starts to drop at 1.23 at % Co (Co-NG5).

The changes of HER activity with the increase of the Co content are more clearly revealed by the η@ 10 mA cm⁻² for each sample (FIG. 16B). Analyzing the Tafel plots of these Co-NG samples yields Tafel slope values in the range of 82 to 132 mV decade⁻¹ (FIG. 17). The variation of the Tafel slope values may reflect the changes in HER mechanism in samples with different Co contents, as the active sites in the catalyst with higher Co content are more likely to be in closer proximity, which could affect the bonding of the intermediates during HER process.

### Example 1.15. Nitrogen-Doping Level on the Influence of the HER Activity of Co-NG

Samples with different nitrogen doping levels were prepared by varying the doping time. For example, 15 minute doping time gives 3.2 at % N, 30 minutes gives 5.3 at % N and 60 minutes gives 8.5 at % N. Further increase in doping time results in no gain in N doping level, indicating 8.5 at % N is the saturation doping level. The XPS characterization (FIGS. 19-20) on these three different samples show similar peak features but with shorter annealing time resulting in smaller N peak intensities. The electrochemical measurements (FIG. 21) show that the sample with 8.5 at % N has the highest activity and the drop in N doing level leads to the decrease in HER activity.

### Example 1.16. Nitrogen-Doping Temperature on the Influence of the HER Activity of Co-NG

To investigate the influence of annealing temperature on the HER activity, a series of Co-NG catalysts were prepared by varying the nitrogen-doping temperature from 350° C. to 850° C. The C, N and O contents in these samples were determined by XPS and shown in Table 3. The Co content is kept the same and not included. The C content was increased linearly as the doping temperature was increased. At the same time, the 0 content approximately followed a decreasing trend, indicating a higher degree of reduction at higher temperature. The N can be successfully doped into the GO at a temperature as low as 350° C. with 3.1 at % N and the N content kept increasing up to 8.5 at % at 750° C.

Further increase in doping temperature resulted in a lower N doping level. The XPS N 1s peak can be deconvoluted into different types of N species, as has been shown in FIG. 3. Similarly, the percentages of the N species in these samples can be obtained by deconvolving the N1s peaks and the results are shown in FIG. 23.

As the temperature is increased, there was a decreasing trend for pyrrolic N and an increasing trend for quaternary N species, indicating that the quaternary N is the stable species at high temperatures. The pyridine/Co—N species are the dominant species at high temperatures.

The HER activity of these samples were investigated in 0.5 M H₂SO₄. FIGS. 22A-B show the polarization curves and the η@ 10 mA cm⁻² for all the samples, respectively. The samples prepared at 350° C. and 450° C. show low HER activity with onset η larger than −300 mV and the η@10 mA cm⁻² are well above 600 mV, compared to ˜480 mV needed for NG. There is a sudden increase in the HER activity when the annealing temperature was increased to 550° C., at which the η@ 10 mA cm⁻² drops sharply to below 300 mV. This suggests that a high temperature (e.g., >550° C.) is necessary to induce the coupling or coordination between the Co and N atoms in the Co-NG catalyst. The HER activities keep increasing up to 750° C. and then start to decrease at 850° C., at which temperature the N content is only 4.3 at %.

### Example 1.17. Turnover Frequency (TOF) Calculations

The per-site turnover frequency (TOF) value was calculated according to the following equation:

$$TOF ( {H}_{2} \text{/} S ) = \frac{\# total hydrogen turnovers pet geometric area}{\# active sites per geometric area} \qquad ( 1 )$$

The number of total hydrogen turnovers was calculated from the current density extracted from the LSV polarization curve according to the following equation:

$$\# total hydrogen turnovers per geometric area = ( \vert j \vert \begin{matrix}mA \\ {cm}^{2}\end{matrix} ) ( \frac{1 C \text{/} a}{1000 mA} ) ( \frac{1 mol {c}^{2}}{96435.2 C} ) ( \frac{1 mol}{2 mol {c}^{2}} ) ( \frac{6.022 \times {10}^{15} molecules {H}_{2} }{1 mol {H}_{2}} ) = 3.12 \times {10}^{15} \frac{{H}_{2} \text{/} a}{{cm}^{2}} per \frac{mA}{{cm}^{2}} \qquad ( 2 )$$

The number of active sites in Co-NG catalyst was calculated from the mass loading on the glassy carbon electrode, the Co contents and the Co atomic weight, assuming each Co center accounts for one active site:

$$\begin{matrix}\# active sites = ( \frac{\begin{matrix}catalyst loading per geometric areas \\ ( \times g \text{/} {cm}^{2} ) \times Co wt \%\end{matrix}}{Co {M}_{w} ( g \text{/} mpl )} ) \\ ( \frac{6.022 \times {10}^{23} Co atoms}{1 mol Co} ) \\ = ( \frac{0.285 \times {10}^{- 3} g \text{/} {cm}^{2} \times 2.48 wt \%}{58.93 g \text{/} mol} ) \\ ( \frac{6.022 \times {10}^{22} Co atoms}{1 mol Co} ) \\ = 7.2 \times {10}^{16} Co sites per {cm}^{2}\end{matrix} \qquad ( 3 )$$

Finally, the current density from the LSV polarization curve can be converted into TOF values according to:

$$TOF = ( \frac{3.12 \times {10}^{15}}{7.2 \times {10}^{16}} \times \vert j \vert ) = 0.0435 \times \vert j \vert \qquad ( 4 )$$

The TOF value was calculated at thermodynamic potential (0 V vs RHE), with the j=j₀=0.125 mA cm⁻², where j₀ is the exchange current. The calculated TOF (at 0 V) was 0.0054 H₂ s⁻¹.

### Example 1.18. Electrochemically Active Surface Area (ECSA) and Active Sites Density Measurements

The ECSA for the Co-NG electrode with mass loading of 285 μg cm⁻² was estimated from the electrochemical double-layer capacitance (C_{dl}) of the catalytic surface. The C_{dl} was determined from the scan-rate dependence of CVs in a potential range where there is no Faradic current. The results are shown in FIG. 24, which yields C_{dl}=29.5 mF cm⁻². The ECSA can be calculated from the C_{dl} according to:

$$ECSA = \frac{{C}_{dl}}{{C}_{s}} \qquad ( 5 )$$

In the aforementioned equation, Cₛ is the specific capacitance of a flat standard electrode with 1 cm² of real surface area, which is generally in the range of 20 to 60 μF cm⁻². If the averaged value of 40 μF cm⁻² is used for the flat electrode, Applicants obtain the following:

$$ECSA = \frac{{C}_{dl}}{{C}_{g}} = \frac{29.5 mF {cm}^{- z}}{40 mF {cm}^{- z} per {cm}_{ECSA}^{2}} = 738 {cm}_{ECSA}^{2} \qquad ( 6 )$$

If Applicants divide the as-obtained ECSA by the loading density of Co centers on the electrode (Co sites per cm²), Applicants can get the averaged area to find one Co center (cm² per site):

$${A}_{ECSA per site} = \frac{ECSA}{\# active sites} = \frac{738 {cm}_{ESCA}^{2} per {cm}_{real}^{2}}{7.2 \times {10}^{16} Co sites per {cm}_{real}^{2}} = 1.03 \times {10}^{- 14} {cm}_{ECSA}^{2} per Co or 1.03 {nm}_{ECSA}^{2} per Co \qquad ( 7 )$$

The aforementioned calculation corresponds to ˜20 benzene per Co in the Co-NG catalyst, assuming one benzene ring has an area of 0.05 nm². The active sites density can be obtained by the inverse of the A_{ECSA per site}:

$$Active sites density ( sited {cm}^{- 2} ) = \frac{1}{{A}_{ECSA per site}} = 9.7 \times {10}^{13} sites {cm}^{- 2} \qquad ( 8 )$$

### Example 1.19. Characterizations of the Catalysts after Cycling Performance

The catalysts after cycling were firstly purified by at least five cycles of repeated centrifugation and redispersion in ethanol to get rid of the nafion, which was used as polymer binder during the preparation of electrodes. Then, the washed catalysts were dried and collected to allow further characterizations. The XPS survey spectrum is shown in FIG. 26, which shows the presence of C, N and O, along with F and S resulting from the residue nafion and electrolyte, respectively. The Co 2p and N 1s spectra are shown in FIG. 27. The peak positions and shapes are similar to those before cycling, indicating the chemical states of Co and N were not altered by cycling. The cycled sample were also characterized by XRD and compared to that before cycling. The results (FIG. 28) show that in both samples there were peaks corresponding to the graphitic structure, but no peaks from Co-derived particles were observed.

Finally, the cycled sample was characterized by STEM. The HAADF image (FIG. 29) shows that the cobalt remains in atomic scale without severe aggregation. Efforts to get clearer images failed, probably due to the difficulty in the complete removal of the binder nafion. From the above analysis, it can be concluded that this Co-NG catalyst is stable in structure and electrochemical performance.

### Example 1.20. Calibration of Reference Electrodes

Hg/HgSO₄, K₂SO₄ (sat) and Hg/HgO, NaOH (1 M) reference electrodes were both calibrated with respect to the reversible hydrogen electrode (RHE). The calibration was conducted in a H₂-saturated electrolyte with Pt wires as both the working electrode and counter electrode. CVs were performed at a scan rate of 1 mV s⁻¹, and the averaged value of the two potentials at which the anodic and cathodic scan crossed zero current was taken to be the thermodynamic potential for the hydrogen electrode reaction. According to the results shown in FIGS. 30-31, in 0.5 M H₂SO₄, E (RHE)=E (Hg/HgSO₄)+0.702 V, while in 1 M NaOH, E (RHE)=E (Hg/HgO)+0.901 V.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. An electrocatalyst comprising:
a surface; and
a plurality of catalytically active sites associated with the surface, wherein the catalytically active sites comprise:
heteroatoms, and
individually dispersed metallic atoms associated with the heteroatoms.

2. The electrocatalyst of claim 1, wherein the surface is selected from the group consisting of carbon materials, graphite, graphitic surfaces, graphite oxide, graphene, graphene oxide, graphene nanoribbons, graphene oxide nanoribbons, carbon nanofibers, carbon nanotubes, split carbon nanotubes, activated carbon, carbon black, metal chalcogenides, molybdenum disulfide, molybdenum trisulfide, titanium diselenide, molybdenum diselenide, tungsten diselenide, tungsten disulfide, niobium triselenide, functionalized surfaces, pristine surfaces, doped surfaces, reduced surfaces, porous surfaces, porous carbons, high surface area porous carbons, high surface area porous carbons made from asphalt, stacks thereof, and combinations thereof.

3. The electrocatalyst of claim 1, wherein the surface is in the form of a sheet.

4. The electrocatalyst of claim 1, wherein the surface comprises a single layer.

5. The electrocatalyst of claim 1, wherein the surface comprises a plurality of layers.

6. The electrocatalyst of claim 1, wherein the surface comprises graphene oxide.

7. The electrocatalyst of claim 1, wherein the surface is porous.

8. The electrocatalyst of claim 1, wherein the metallic atoms are associated with the heteroatoms through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

9. The electrocatalyst of claim 1, wherein the metallic atoms are coordinated with the heteroatoms.

10. The electrocatalyst of claim 1, wherein the heteroatoms form an interconnected network, and wherein the metallic atoms are individually dispersed within the interconnected network.

11. The electrocatalyst of claim 1, wherein the heteroatoms are selected from the group consisting of boron, nitrogen, oxygen, phosphorous, silicon, sulfur, chlorine, bromine, iodine, and combinations thereof.

12. The electrocatalyst of claim 1, wherein the heteroatoms comprise nitrogen.

13. The electrocatalyst of claim 1, wherein the heteroatoms have a concentration ranging from about 0.5 at % to about 10 at % of the electrocatalyst.

14. The electrocatalyst of claim 1, wherein the heteroatoms have a concentration ranging from about 3 at % to about 9 at % of the electrocatalyst.

15. The electrocatalyst of claim 1, wherein the metallic atoms are selected from the group consisting of metals, metal oxides, transition metals, metal carbides, transition metal oxides, cobalt, iron, nickel, molybdenum, platinum, palladium, gold, manganese, copper, zinc, and combinations thereof.

16. The electrocatalyst of claim 1, wherein the metallic atoms comprise cobalt.

17. The electrocatalyst of claim 1, wherein the metallic atoms exclude at least one of platinum, gold, palladium, and combinations thereof.

18. The electrocatalyst of claim 1, wherein the metallic atoms have a concentration of less than about 3.0 at % of the electrocatalyst.

19. The electrocatalyst of claim 1, wherein the metallic atoms have a concentration ranging from about 0.01 at % to about 2.0 at % of the electrocatalyst.

20. The electrocatalyst of claim 1, wherein the electrocatalyst is capable of mediating oxygen reduction reactions, oxygen evolution reactions, hydrogen oxidation reactions, hydrogen evolution reactions, and combinations thereof.

21. The electrocatalyst of claim 1, wherein the electrocatalyst is capable of mediating hydrogen evolution reactions.

22. The electrocatalyst of claim 1, wherein the electrocatalyst is capable of mediating hydrogen evolution reactions and oxygen evolution reactions.

23. A method of mediating an electrocatalytic reaction, said method comprising:
exposing a precursor material to an electrocatalyst, wherein the electrocatalyst comprises:
a surface; and
a plurality of catalytically active sites associated with the surface, wherein the catalytically active sites comprise:
heteroatoms, and
individually dispersed metallic atoms associated with the heteroatoms.

24. The method of claim 23, wherein the exposing occurs by a method selected from the group consisting of mixing, stirring, incubating, sonicating, heating, ion implantation, mechanical mixing, and combinations thereof.

25. The method of claim 23, wherein the electrocatalytic reaction is selected from the group consisting of oxygen reduction reactions, oxygen evolution reactions, hydrogen oxidation reactions, hydrogen evolution reactions, and combinations thereof.

26. The method of claim 23, wherein the electrocatalytic reaction comprises hydrogen evolution reactions.

27. The method of claim 23, wherein the electrocatalytic reaction is a hydrogen evolution reaction, and wherein the exposing results in formation of molecular hydrogen from the precursor material.

28. The method of claim 27, wherein the precursor material is water.

29. The method of claim 23, wherein the surface is selected from the group consisting of carbon materials, graphite, graphitic surfaces, graphite oxide, graphene, graphene oxide, graphene nanoribbons, graphene oxide nanoribbons, carbon nanofibers, carbon nanotubes, split carbon nanotubes, activated carbon, carbon black, metal chalcogenides, molybdenum disulfide, molybdenum trisulfide, titanium diselenide, molybdenum diselenide, tungsten diselenide, tungsten disulfide, niobium triselenide, functionalized surfaces, pristine surfaces, doped surfaces, reduced surfaces, porous surfaces, porous carbons, high surface area porous carbons, high surface area porous carbons made from asphalt, stacks thereof, and combinations thereof.

30. The method of claim 23, wherein the surface comprises graphene oxide.

31. The method of claim 23, wherein the metallic atoms are associated with the heteroatoms through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

32. The method of claim 23, wherein the metallic atoms are coordinated with the heteroatoms.

33. The method of claim 23, wherein the heteroatoms form an interconnected network, and wherein the metallic atoms are individually dispersed within the interconnected network.

34. The method of claim 23, wherein the heteroatoms are selected from the group consisting of boron, nitrogen, oxygen, phosphorous, silicon, sulfur, chlorine, bromine, iodine, and combinations thereof.

35. The method of claim 23, wherein the heteroatoms comprise nitrogen.

36. The method of claim 23, wherein the heteroatoms have a concentration ranging from about 0.5 at % to about 10 at % of the electrocatalyst.

37. The method of claim 23, wherein the heteroatoms have a concentration ranging from about 3 at % to about 9 at % of the electrocatalyst.

38. The method of claim 23, wherein the metallic atoms are selected from the group consisting of metals, metal oxides, transition metals, metal carbides, transition metal oxides, cobalt, iron, nickel, molybdenum, platinum, palladium, gold, manganese, copper, zinc, and combinations thereof.

39. The method of claim 23, wherein the metallic atoms comprise cobalt.

40. The method of claim 23, wherein the metallic atoms have a concentration of less than about 3 at % of the electrocatalyst.

41. The method of claim 23, wherein the metallic atoms have a concentration ranging from about 0.01 at % to about 2 at % of the electrocatalyst.

42. A method of making an electrocatalyst, said method comprising:
associating a surface with heteroatoms and metallic atoms,
wherein the associating results in the formation of a plurality of catalytically active sites, and
wherein the catalytically active sites comprise individually dispersed metallic atoms associated with the heteroatoms.

43. The method of claim 42, wherein the associating occurs by a method selected from the group consisting of mixing, stirring, sonication, freeze-drying, hydrothermal treatment, annealing, chemical vapor deposition, evaporation, mechanical mixing, ion implantation, and combinations thereof.

44. The method of claim 42, wherein the heteroatoms are associated with the surface after the metallic atoms are associated with the surface.

45. The method of claim 42, wherein the heteroatoms are associated with the surface before the metallic atoms are associated with the surface.

46. The method of claim 42, wherein the heteroatoms and the metallic atoms are simultaneously associated with the surface.

47. The method of claim 42, wherein the metallic atoms are associated with the surface through freeze-drying.

48. The method of claim 42, wherein the heteroatoms are associated with the surface through annealing.
